(19) United States
(12) Patent Application Publication
(10) Pub. No.: US 2006/0195909 A1
(43) Pub. Date: Aug. 31, 2006

(54) Media player operable to decode content data

(75) Inventors: Jeremy Mayo Boswell, Llantwit Major (GB); Jonathan Mark Kendrick, Claverley (GB); Timothy John Revell, Perton (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Rok Productions Limited, Wolverhampton (GB)

(21) Appl. No.: 11/360,722

(22) Filed: Feb. 23, 2006

(30) Foreign Application Priority Data
Feb. 25, 2005 (GB) 0504013.4
Jun. 14, 2005 (GB) 0512086.0
Feb. 10, 2006 (GB) 0602756.9

(51) Int. Cl. H04N 7/16

(52) U.S. Cl. 726/26

(57) ABSTRACT

Content is provided on a medium or is transmitted, for example streamed, with in-built protection against unauthorised playback or copying. Video content data is provided in content blocks, each of which relates to a video frame and has a corresponding header. Some content clocks have an excess data item, such as a digital fingerprint, interposed somewhere in the data comprising that content block. Thus, the amount of the data in the content block is increased by the addition of the digital fingerprint. Information identifying the length of the content block in the corresponding header is not altered. Some or all content blocks are obfuscated following the additional of the digital fingerprints. In a media player, de-obfuscation is performed, and digital fingerprints then removed before the resulting content blocks are decoded. Without de-obfuscation and removal of the digital fingerprints, correct decoding would not occur. Thus, playback of the content is limited to a media player that knows the de-obfuscation scheme used and knows the locations of the digital fingerprints.

### FIELD OF THE INVENTION

This invention relates to a media player operable to decode data and to apparatus comprising means for producing a media player operable to decode content data.

### BACKGROUND TO THE INVENTION

Providing content subject to copyright on portable storage media and the like for playback on mobile devices introduces the possibility of interested persons being able to make illegal copies of the content, for distribution without the consent of, or payment to, the owner of the copyright.

It is known to stream coded video and audio data to mobile devices, for decoding and playback thereon. One such service is operated by Sprint PCS Vision Multimedia Services. However, supplying content which is subject to copyright in this way can make it vulnerable to being intercepted by interested third parties, even when GPRS or a 3G data service is used for delivery. Content so provided could also be recorded, by persons with suitable technical proficiency, in a form in which it could be used for unauthorised copying of the content.

It is conventional to use encryption to protect content which is subject to copyright. In this way, only recipients provided with a correct encryption key can decrypt the content and consequently decode it properly for playback. Weak protection can be obtained using relatively short keys. Stronger protection requires longer encryption keys to be used. However, decryption places a processing overhead on the receiver. In the case of mobile devices, the process of decryption results in the consumption of significant amounts of electrical power, thereby decreasing the time it takes for the battery to discharge to a level which is insufficient to continue powering the mobile device. Stronger encryption requires more processing to decrypt the same amount of content data, thereby exasperating the problem. Encryption of content does not prevent recording, by persons with suitable technical proficiency and the decryption key or keys, of decrypted content in a form in which it could be used for unauthorised copying of the content.

Thus, the inventors have perceived a need for the protection of content which can place less processing overhead on devices which are intended to decrypt and playback the content. The inventors have also perceived a need for the protection of content from persons who may be interested in authorised copying of the content.

### SUMMARY OF THE INVENTION

According to the invention, there is provided a media player operable to decode content data, the media player being arranged to use excess data location information to identify the location of each of plural excess data items within content blocks forming part of the content data, to remove the excess data from the locations so determined, and to decode the content data following removal of the excess data.

This can allow playback of the content to be limited to media players which are authorised to playback the content. Furthermore, authorisation can be made content item specific or content generic. Other advantages will be appreciated from the description of the embodiments described below.

Preferably, the excess data location information is obtained over a channel separate from a source of the content data. This allows control over which media players are allowed to playback the content, since the excess data location information is separated from the content data. Furthermore, the ability to playback the content can be limited to media players held by users whom have paid for or otherwise obtained a licence to playback the content.

Further preferably, each occurrence of the excess data is a digital fingerprint. In this way, the excess data can be such that it is very difficult or impossible to identify within the content data, yet is able to be verified as the excess data by a media player that has the excess data location information.

Advantageously, the media player is arranged to determine whether data forming part of an authorisation code includes data corresponding to the digital fingerprint, and to decode the content data only in response to a positive determination. This can allow further protection of the content data since the media player will play back the content only if the location of the fingerprints and the fingerprint is known. This leads to the further advantage that a single excess data location pattern can be used with different digital fingerprints. In particular, the content can be allowed to be played back by one or more media players which have the excess data location information and the fingerprint, whilst disallowing playback by one or more media players which have the excess data location information but do not know the fingerprint. The authorisation code may be a media code. A media code may additionally include information allowing playback to be restricted to a particular mobile device, for instance by its IMEI number.

If each of the digital fingerprints comprises a data sequence which is the same for each occurrence of the digital fingerprint, the locations of the fingerprints can be verified by a media player on the basis of an unlock code or other means including less data than for a corresponding system in which numerous different fingerprints were present in the content.

Preferably, the media player is arranged to determine whether data forming part of an authorisation code includes data corresponding to a serial number of the media player, and to decode the content data only in response to a positive determination. This allows the use of authorisation codes which are specific to a particular media player. Thus, an authorisation code obtained by user who has purchased or otherwise obtained a licence for playback of content on their device cannot be used also by other media players, thereby limiting content playback to a single media player.

Advantageously, the media player is operable to derive the excess data location information from the authorisation code. This allows the media player to obtain all or most of the information it needs to playback the content from a single authorisations code, which provides a substantial amount of protection for the content whilst allowing authorisation of a media player to playback the content through a relatively simple authorisation process.

The media player can be operable to use pre-programmed information to identify content blocks in which the excess data is located, and to use the excess data location information to determine the location of the excess data within those content blocks. This allows effective content protection whilst allowing a relatively simple function in the media player to playback the content correctly when authorised to do so. The amount of data needed to achieve this can be quite small, allowing authorisation to be carried out over limited channels, for instance SMS.

The media player preferably is stored on a portable memory device along with one or more items of content, each item of content being provided with excess data, and an unlock file.

Advantageously the unlock file includes a portable memory device serial number, and wherein the media player is arranged to validate a serial number of the portable memory device with the portable memory device serial number included in the unlock file before allowing playback of an item of content.

In either case, the unlock file may include a media player serial number, and wherein the media player may be arranged to validate a serial number of the media player with the media player serial number included in the unlock file before allowing playback of an item of content.

The unlock file may include a respective unlock code for each item of content. In this case, the media player may be arranged to supplement the unlock file with an unlock code for a new item of content and to overwrite the unlock file stored on the portable memory device.

According to another aspect of the invention, there is provided apparatus comprising means for producing a media player operable to decode content data, the media player being arranged to use excess data location information to identify the location of an excess data item within each of plural content blocks forming part of the content data, to remove the excess data from the locations so determined, and to decode the content data following removal of the excess data.

### BRIEF DESCRIPTION OF THE DRAWINGS

Embodiments of the present invention will now be described by way of example with reference to the accompanying drawings, in which:

FIG. 1 is a schematic diagram of audio-visual content provision apparatus useful in understanding the invention;

FIGS. 2 and 3 are flowcharts illustrating steps of operation of the FIG. 1 apparatus;

FIG. 4 is a schematic drawing illustrating apparatus for playback of the converted audio-visual content in a mobile telephone according to the invention;

FIG. 5 illustrates a combination of an MMC and the mobile telephone of FIG. 4;

FIGS. 6 and 7 illustrate alternative embodiments of MMC hardware, useful in understanding the invention;

FIG. 8 is a flowchart illustrating security validation between the mobile telephone of FIG. 4 and the MMC of FIG. 6 or FIG. 7;

FIG. 9 shows content stored on an MMC, and is useful in understanding the invention;

FIGS. 10A, 10B, 10C and 10D show content blocks stored in the FIG. 9 MMC, their creation and their use in a media player according to the invention;

FIG. 11 is a schematic diagram illustrating components of a broadcast server operable with a media player according to the present invention; and

FIG. 12 is a schematic block diagram illustrating components of a media player operable according to the present invention;

FIG. 13 is a schematic diagram of components of a system through which a terminal is able to obtain content and operate according to the invention; and

FIG. 14 is a schematic diagram of an MMC having a media player according to the invention stored on it.

Throughout the drawings, reference numerals are re-used for like elements.

### DETAILED DESCRIPTION OF THE PREFERRED EMBODIMENTS

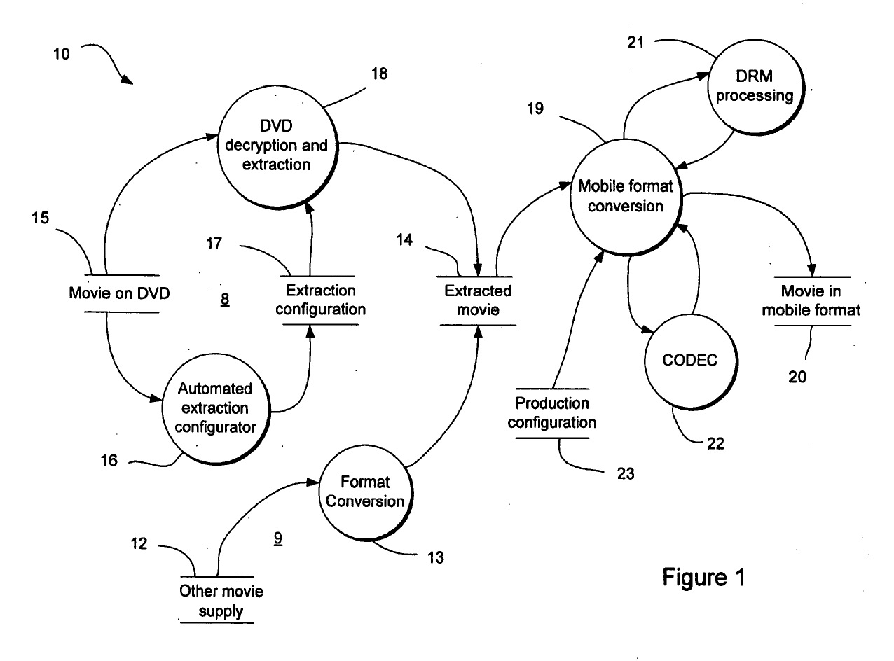

Referring firstly to FIG. 1, content extracting and converting apparatus 10 is illustrated schematically. Two alternative sources of audio-visual content 8, 9 are included. A first content source 8 utilises film or movie data stored on a DVD (digital video disk or digital versatile disk) 15. An automated extraction configuration module 16 examines metadata stored on the DVD 15 to determine the configuration of content data stored on the DVD. This involves the application of a tcprobe, and an analysis of the information returned from the DVD 15. This is described in more detail below. The result is data stored in an extraction configuration memory area 17 representing an extraction configuration. The extraction configuration data from the memory area 17 is utilised by a DVD decryption and extraction module 18 to extract movie data (i.e. the content data) from the DVD 15. The result is content data in an intermediate format, which is written to an intermediate format movie data area 14. The data included in the intermediate format movie data area 14 is in predetermined format and is suitable for conversion into a form ready for reproduction on a mobile telephone (not shown). Preferably the intermediate format is AVI. This format has the advantage of high resolution, yet is relatively easy to handle and it is relatively easy to convert from AVI into 3GPP and many other formats suitable for use by mobile devices.

The second source of audio-visual content 9 receives from a movie data storage area 12 data representing a movie (or film) in AVI (audio-visual interleave) or other format. The movie so supplied is converted by a format conversion module 13 before being written to the intermediate format movie data area 14.

Thus, either of the audio-visual content sources 8, 9 can be used to provide movie data in the intermediate format movie data area 14.

A mobile format conversion module 19 converts movie data stored in the extracted movie data area 14 and provides a movie in mobile telephone consumable format in a mobile format movie data area 20. The mobile format conversion module 19 utilises a digital rights management (DRM) processing module 21, which allows certain control over the access and distribution of the resulting movie data. The conversion effected by the mobile format conversion module 19 uses a codec 22, which preferably is custom-designed for the purpose. Importantly, the conversion effected by the mobile format conversion module 19 uses information stored in a production configuration data area 23. By controlling the mobile format conversion module 19 on the basis of information specific to the configuration of, and thus tailored to, a target device, the apparatus 10 can be used to provide movie data for any of potentially a large number of target mobile devices.

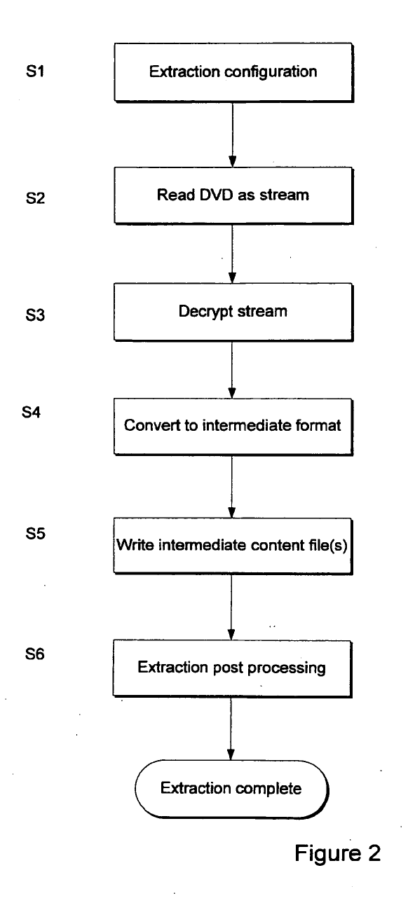

The extraction effected by the audio-visual content source 12 will now be described in detail with reference to FIG. 2.

In FIG. 2, extraction configuration is effected at step S1. This utilises the automated extraction configuration 16 shown in FIG. 1. Extraction configuration commences by analysing the DVD source 15. The result of an example analysis, i.e. what is returned in response to a query, is illustrated below:

(dvd_reader.c) mpeg2 pal 16:9 only letterboxed U0 720×576 video

(dvd_reader.c) ac3 en drc 48 kHz 6 Ch

(dvd_reader.c) ac3 de drc 48 kHz 6 Ch

(dvd_reader.c) ac3 en drc 48 kHz 2 Ch

(dvd_reader.c) subtitle 00=<en>

(dvd_reader.c) subtitle 01=<de>

(dvd_reader.c) subtitle 02=<sv>

(dvd_reader.c) subtitle 03=<no>

(dvd_reader.c) subtitle 04=<da>

(dvd_reader.c) subtitle 05=<fi>

(dvd_reader.c) subtitle 06=<is >

(dvd_reader.c) subtitle 07=<en>

(dvd_reader.c) subtitle 08=<de>

[tcprobe] summary for /media/dvdrecorder/, (*)=not default, 0=not detected import frame size: −g 720×576 [720×576]

aspect ratio: 16:9 (*)
frame rate: −f 25.000[25.000] frc=3
audio track: −a 0 [0]−e 48000, 16, 2 [48000, 16, 2] −n 0x2000 [0x2000]
audio track: −a 1 [0]−e 48000, 16,2 [48000,16,2]−n 0x2000 [0x2000]
audio track: −a 2 [0]−e 48000,16,2 [48000,16,2]−n 0x2000 [0x2000]
   [tcprobe] V: 185950 frames, 7438 sec @ 25.000 fps
   [tcprobe] A: 116.22 MB @ 128 kbps
   [tcprobe] CD: 650 MB V: 533.8 MB @ 602.0 kbps
   [tcprobe] CD: 700 MB V: 583.8 MB @ 658.4 kbps
   [tcprobe] CD: 1300 MB V: 1183.8 MB @ 1335.1 kbps
   [tcprobe] CD: 1400 MB V: 1283.8 MB @ 1447.9 kbps

This information is returned by tcprobe, which is part of transcode. Part of the extraction configuration process of S1 involves determining the configuration of the target device, which is represented by the information stored in the production configuration data area 23. It is helpful therefore to understand the information that is stored there.

Information data stored in the production configuration data area 23 identifies the aspect ratio of the display of the target device. In most cases, the aspect ratio 4:3, although this may vary form device to device. Certain devices will include 16:9 (widescreen) aspect ratios, although in practice the aspect ratio may take a value which is not the same as a conventional television aspect ratio. The production configuration data also identifies the audio language required. It also identifies whether or not subtitles are required. If they are required, the production information configuration identifies the language that the subtitles are required to be in. The bitrates of the video and the audio tracks are included in the production configuration data. The bitrates may depend on the capabilities of the target device, on the particular media player installed in the target device or on any other factors. The production configuration data may also indicate a maximum volume size, for example indicating the amount of usable memory in an MMC. The production configuration information also includes an indication of the format on which the movie data is to be stored. For example, this format can be 3GPP or MPEG-4 format, or any other suitable format.

The information included in the production configuration data area 23 also includes the type of the target device. This may be, for example, a model number of the mobile telephone on which the movie is to be reproduced. In some circumstances, it may be possible that two different mobile telephones having the same model number can have different hardware and/or software configurations. Where different configurations are possible, and this may have a bearing on the optimum processing effected by the apparatus 10, the information stored in the production configuration data area 23 preferably also includes details of how the hardware and/or software configuration departs from the standard configuration, or perhaps instead merely specifies the configuration.

The automated extraction configuration module 16 determines from the information returned by tcprobe, (in particular the first line thereof reproduced above) that the DVD 15 contains only widescreen (that is 16:9 aspect ratio) video in MPEG 2 PAL format. The module 16 also determines that there are three audio tracks, identified by the second and fourth lines respectively. The first and second tracks have 6 channels each and 48 kHz sampling rates. The first is in the English language and the second is in the German language, as identified by the “en” and “de” designations. The third audio track is in the English language and is a stereo (two channel) signal having a 48 kHz sampling rate. The module determines also that the DVD 15 has eight subtitle tracks, in various languages. The module 16 also determines the frame rate, the number of frames and the length of the movie. The module 16 uses the last four lines of the returned information to determine the content bitrate variations that can be extracted from the DVD 16.

The function of the automated extraction configuration module 16 also includes obtaining decryption keys, which are needed to allow the audio-visual content on the DVD to be reproduced.

The information determined by the automated extraction configuration module 16 constitutes the configuration of the DVD 15.

Based on the information in the production configuration data area 23 and on the DVD configuration information, the automated extraction configuration module 16 makes a decision as to which audio tracks, which video channel (if there is more than one video channel) and which subtitle track are needed. Typically, the subtitle track identified by this process is the first listed subtitle track which is in the same language as the subtitle language identified in the production configuration data area 23. Also, the audio track identified by this process is the audio track which is in the same language as the audio language identified in the production configuration data area 23 and which is most suitable for use by the target device. In most cases, Dolby™ Pro Logic™ audio channels will not be suitable, because most target devices will not be equipped to handle such audio signals. A stereo audio track will in most cases be the most suitable audio track, although any mono track may be most suitable for a target device with only mono audio capabilities. The video channel selected by this process typically is the main channel, i.e. the actual movie, and not any ‘additional features’, such as trailers and behind-the-scene documentaries and the like that are commonly included on DVDs. Data identifying the tracks and channels identified by this process is stored in the extraction configuration data area 17.

In step S2, the data stored on the DVD 15 is read as a stream. This is represented by the arrow between the movie on DVD data area 15 and the DVD decryption and extraction module 18 in FIG. 1. It is only the content which is read at this time, since the configuration information, or metadata, is not used by the DVD decryption and extraction module 18 directly. Also, it is only the relevant content which is read. The relevant content is identified to the DVD decryption and extraction module 18 by the information stored in the extraction configuration data area 17, which identifies the relevant video channel, the relevant audio channel and any relevant subtitle channel. At step S3, the relevant portions of the DVD data stream are decrypted by the DVD decryption and extraction module 18. This decryption uses transcode with the keys extracted by the automated extraction configuration module 16. Decryption is performed “on the fly”, i.e. as a continuous process as the content is read from the DVD 15. As the data is decrypted, it is converted into the intermediate format, i.e. AVI format. At step S5, the movie data is written into the extracted movie data buffer 14 as a file or series of files in the intermediate format.

At step S6, extraction post-processing is performed. This involves splitting or joining the content file or files present in the extracted movie data buffer 14 into components. Whether there is any splitting or any joining and the extent of it depends on the target device configuration information stored in the production configuration data area 23. In most cases, this step will involve splitting the extracted content cleanly to multiple volumes. Providing movie content in the form of multiple volumes is desirable in many circumstances due to the limitations of mobile telephones. It is a fairly straightforward procedure to split DVD movie content into volumes corresponding to the DVD chapters present on the original DVD 15. Following step S6, the extraction of the movie data is complete.

The result is movie data stored in the extracted movie data buffer 14 which is encoded into an intermediate format (e.g. AVI format) and which includes only one audio track, which is in the required language identified by the production configuration information stored in production configuration data area 23, and optionally one subtitled track, in the required language. The extracted movie data typically is divided into a number of volumes, although this may not be necessary depending on the configuration of the target device.

Instead of using a DVD data source 15, the other movie data storage area 12 may be used. In this case, format conversion to the intermediate format, for example AVI, is carried out by the format conversion module 13. If only DVD sources 15 will be used, then the second content source 9 can be omitted. If included, the format conversion module 13 takes a form which is suitable for the particular type of content provided at the other movie data storage area 12. A separate format conversion module 13 may be needed for each type of data that can be stored in the other movie data storage area 12.

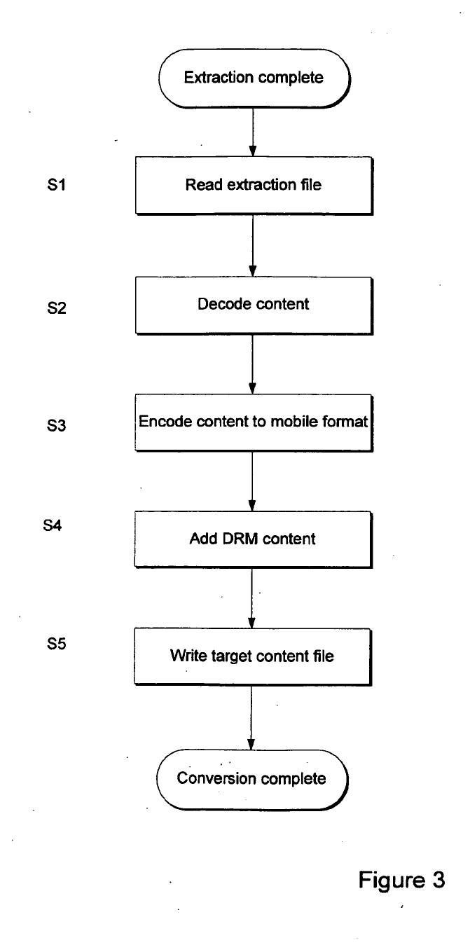

The procedure of FIG. 3 begins with the extraction process complete. At step S1, the extraction file is read. This is an “on the fly” procedure and is represented by the arrow linking the extracted movie data buffer 14 with the mobile format conversion module 19. At step S2, the mobile format conversion module 19 decodes the content comprising the movie data. The step uses transcode. At step S3, the decoded content is encoded into the required mobile format, as identified by the production configuration information stored in the production configuration data area 23. The encoding is performed by the codec 22. The encoding is performed in such a way as to result in audio and video content having the most appropriate bitrates. What are the most appropriate bitrates is determined by the mobile format conversion module 19. In particular, the mobile format conversion module 19 uses knowledge of the number of video frames in the video data and the length of the audio track along with the maximum volume size information stored in the production configuration data area 23 to determine the most suitable bitrates. In most cases, the most suitable bitrates for the audio and video will be the bitrates which are the maximum possible bitrates which could be used to fit the entire content within the maximum volume size.

Usually, the bitrates selected for the audio and the video give rise to comparable quality for those components, although there can be some discrepancy if this results in mobile format movie data which would give an improved playback experience if this is possible having regard to the maximum volume size. For example, if audio and video content at a certain quality level would give rise to data exceeding the maximum volume size but that content at a quality level immediately below that would give rise to a significant shortfall of the volume size, the mobile format conversion module 19 may make a decision to use the higher bitrate for the video content and the lower bitrate for the audio content, so as to make the best use of the available volume size.

If examination of the information stored in the production configuration data area 23 reveals that the target device is not optimised for video playback at the same frame rate as that of the DVD source 15, then this is taken into account by the mobile format conversion module 19. In particular, the mobile format conversion module 19 may modify the frame rate of the content data so that it is optimised for the target mobile device. Typically, this will involve a reduction in the frame rate which, because of the limited display size in most mobile telephones, would not be so noticeable as it would if a full size display were used. If the optimal frame rate is not equal to the source frame rate divided by an integer, then the mobile format conversion module 19 may use frame interleaving to effect a smooth result in the generated movie content when played back on a mobile telephone.

Step S3 thus utilises information stored in the production configuration data area 23 to control the mobile format conversion module 19 to encode the data using the codec 22 into the appropriate data format and with appropriate bitrates.

The production configuration data area 23 may be updatable according to the target device which is of interest in a particular format conversion process. In this case, the production configuration data area 23 will store data for only one target device at a time, and this data is changed as required. Alternatively, the production configuration data area 23 stores a set of data for each of plural target devices, and one of the data sets is selected according to the particular target device of interest at a given time. In either case, the apparatus 10 is easily controlled to carry out a format conversion process which is optimised for each of plural target device configurations.

Digital rights management content is added to step S4. This is implemented by the mobile format conversion module 19 using the DRM processing module 21. The procedure implemented by the step S4 depends on the target format identified by the information stored in the production configuration data area 23. What form of DRM content is added may depend in particular on the form of the codec 22. The form of the codec 22 in turn has an effect on the form of the codec in the media player. In particular, when the codec 22 is a custom codec, a custom form of DRM is used. Here, the form of DRM can be selected to provide optimal operation with the custom media player. If an off-the-shelf codec, such as Real Media™, is used as the codec 22, a suitable DRM is used.

Assuming it is allowed by the media player and the target device, the DRM content may impose content reproduction and distribution restrictions as follows. One option is to limit viewing of the content to the particular target device or user, as for example identified by an IMEI or an IMSI number or any other unique or quasi-unique serial number. In this case, the serial number needs to be included in the production configuration data area 23, so that the mobile format conversion module 19 can operate with the DRM processing module 21 and the production configuration data area 23 to include suitable DRM content in the movie data. Another option is to allow the movie to be viewable up until a particular time and/or date. Thus, the resulting movie will have a “shelf-life” and will not be viewable after the date and/or time specified by the DRM content. A third option is to allow the movie content to be viewable on a predetermined number of occasions (N times). Once the movie has been viewed N times, the media player in the target device will not allow the content to be refused again, thereby rendering it useless. Alternatively, the media player may be arranged to erase the MMC or otherwise delete or corrupt the movie data immediately after the Nth viewing. Alternatively or in addition, the DRM content can prevent the content being copied or forwarded if not authorised. Thus, it can be said that the DRM content prevents or deters the consumption of the content on mobile devices other than the one for which it was intended and/or copying of the content.

Preferably, the DRM content is encrypted and included in the header of the resulting movie data, although the DRM content may be included in the movie data in any suitable way. Clearly, if a standard DRM process is required to be used by the target device, the DRM content included in the movie data by the mobile format conversion module 19 in the DRM processing module 21 will conform to the relevant standard.

The DRM processing module 21 also obfuscates the content at step S4. This is particularly important if the codec 22 is an industry standard codec, since otherwise it might be possible to render the content using a player other than one specifically designed for use with the content. Content obfuscation is performed by a command line-based obfuscation tool, forming part of the DRM processing module 21 as follows.

Content obfuscation is performed in frames. This helps to limit the overall CPU load when de-obfuscation is performed. The particular obfuscation method used depends on what format the content is in. For instance, the obfuscation method used with Real Media™ format content is different to that used with MP3 format content.

Only content data is obfuscated; content headers are not obfuscated. Optionally, only some of the content data frames are obfuscated. Of those content data frames that are obfuscated, some are obfuscated in full and some are only part obfuscated. For instance, key frames may be fully obfuscated, and only a portion (for instance the first ten bytes) of all other frames are obfuscated. Obfuscation involves making calculations such as bit shifting, adding and subtracting certain bytes depending on their position in the stream, etc. The calculations are based on the outcome of a suitable calculation on the timestamp in the content block header. The positions are derived by a modulo of the number of bytes in the content frame for every iterance of the calculation. The particular obfuscation technique used is not critical.

The obfuscation process is selected to as to require a relatively small, preferably minimum, CPU overhead for decoding by a media player when played back on a mobile device.

The first data content block is extended with an obfuscation identifier. This identifier is located at a suitable position in the content block, and the content header is adjusted to reflect the length of the content block including the obfuscation identifier. The obfuscation identifier is useable by a suitable media player to determine what obfuscation method was used by the DRM processing module 21, which allows it to perform the corresponding de-obfuscation method. Following addition of the obfuscation identifier, it may be necessary to correct affected index entries so that seeking can be performed properly.

The obfuscation process used is different for different content batches. For example, the number of affected bytes can vary. Also, different compliments can be used, e.g. ones compliment in one batch and twos compliment in another batch. The obfuscation rules are configurable at content encoding. The obfuscation process used for a particular content batch can be selected randomly.

At step S5, the target content is written to the mobile format movie data area 20 as a file. The file may be an area of memory in a computer server, for instance, or the content file may be written directly onto an MMC or other portable transferable media. The file written by this step S5 includes content in the appropriate format, and also DRM content either embedded into the movie content or else in a separate file. After step S5, the conversion is complete, the result is stored in the mobile format movie data area 20 data constituting the movie originally on the DVD data area 15 but encoded in a format suitable for use by the target mobile device and having appropriate audio and video content bitrates. Furthermore, the movie includes suitable DRM content, multiple volumes if appropriate to the format of the target device, a single audio sound track, and optionally a single subtitle track.

Where the video content on the DVD 15 has a different aspect ratio to the display of the target device, there preferably is modification of the video signal from the DVD such that it corresponds to the aspect ratio of the target device. This can be carried out by the DVD encryption and extraction module 18. Preferably however, modification of the video signal from the DVD 15 such that it corresponds to the aspect ratio of the target device is carried out by the mobile format conversion module 19. The modification may involve simple cropping from the left and right sides of images if narrower images are required, or cropping from the top and bottom of images if wider images are required. The modification may involve aswell or instead a limited amount of image stretching, either widthwise or heightwise. In this case, it is preferred to have more picture linearity in the central region of the display than at the edges of the display. Thus, compression or stretching is effected to a greater degree at the edges of the images than it is a central portion. The DVD encryption and extraction module 18 or the mobile format conversion module 19, as the case may be, can be pre-programmed to make a decision as to what cropping and/or stretching is required on the basis of a look-up table relating course aspect ratios to target device aspect ratios and the corresponding modification required, or in any other suitable way.

In the embodiments described above, the data written to the mobile format movie data area 20 relates only to content data. In an advantageous embodiment, the data written to the mobile format movie data area 20 also includes one or more media players. This is advantageous for a number of reasons. Firstly, it reduces the number of factors which need to be taken into account by the mobile format conversion module 19. The target device configuration information does not need to include information identifying the media player included in the mobile device, since this is not needed when the media player is included with the movie content data. Secondly, it allows movie content data to be consumed even if no suitable media player, or indeed no media player at all, is included in the mobile device.

The media player or players may be embedded, or alternatively included alongside, the movie content data. Embedding the media player into the content data allows easier control of the movie content, and makes it very difficult for the movie content data to be separated by unauthorised persons. Each media player typically consumes less than 1 MB of memory.

In one embodiment, a single custom media player is included with the movie content data. After the data is written onto an MMC card, the data relating to the media player is extracted by the mobile device from the MMC and the media player run to process the movie content data.

In another embodiment, a number of different media players are stored, along with the movie content data and a loader program. The mobile device is controlled to run the loader program initially. The program detects the relevant configuration of the mobile device and determines therefrom which of the media players to use to consume the movie content data. In this way, it is possible to utilise an MMC card for a greater number of target device configurations, which clearly can be advantageous, especially when the MMC cards are intended for retail from a shop display or similar.

If the media player is not a custom player, the loader program preferably is arranged to control the mobile device to detect whether or not it already includes a suitable media player. If a suitable media player is detected, this is controlled to be used instead of installing a media player from the MMC card onto the mobile device. This is advantageous since it reduces the possibility of there being an installation or deinstallation error, thereby improving the reliability of the mobile device.

Instead of including multiple separate media players, multiple media players may be provided through a single configurable media player software application. In this case, the loader program may determine what media player is required, and operate appropriate software modules forming part of the media player software. Software module or functions which are not appropriate for the mobile device configuration are not used. Thus, multiple media players are made up from a single software application, which reuses modules or functions for certain media player functionality. Where a single media player software application is used, the loader program may form part of the media player software application itself.

Any media player written to the mobile format movie data area 20 is able to render content, so includes suitable de-obfuscation functionality.

The movie content data, as well as any media player(s), stored in the mobile format movie data area 20 can be communicated to the target mobile device in any suitable way. For the next few years at least, it is envisaged that mostly MMC or other transferable media will be used to store and transport the movie content. However, as mobile data transfer becomes faster and cheaper, it is expected that movie content will be transferable over-the-air, for example using WAP or 3G data transfer. Transfer may instead be effected by transfer from an Internet connected PC which has downloaded the movie content from a website, using a short range link such as a cable, or wirelessly using IrDA or Bluetooth, or using a transferable storage medium such as an MMC.

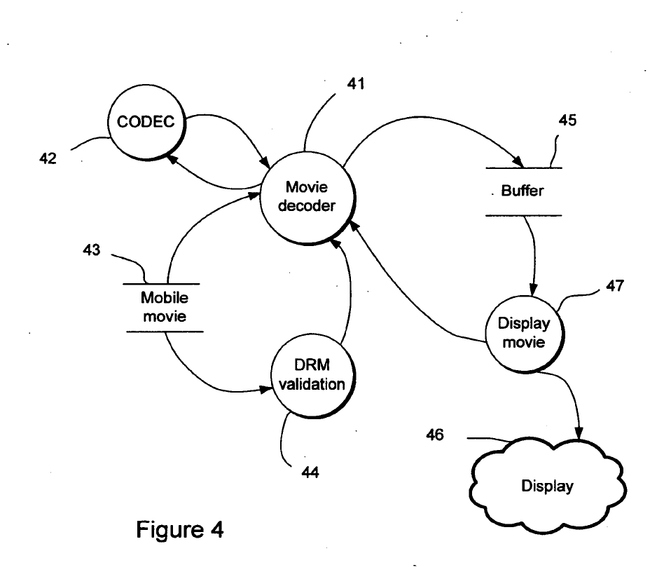

A mobile device is shown schematically in FIG. 4. Here, the mobile telephone 40 includes all the conventional components needed for voice communication, although these are not shown for the sake of clarity. The telephone 40 includes a movie decoder module 41, which is in bidirectional communication with a codec 42. A movie is stored in a mobile movie data area 43, which may take any suitable form. It may for example be an MMC, a memory space connected by way of an external drive, internal RAM or other memory, or it may take any other suitable form. A DRM validation module 44 is connected to receive DRM data from the data in the mobile movie data area 43. The DRM validation module 44 controls the movie decoder module 41 to allow or disallow it to decode the movie data from the mobile movie data area 43 on the basis of a decision made using the DRM data, and time/date or serial number inputs as appropriate. When allowed by the DRM validation module 44 to decode movie data from the mobile movie data area 43 and when controlled to do so by user input, the movie decoder module 41 uses the codec 42 to decode the data and provide decoded data to a buffer 45. From the buffer 45, the movie is displayed on a display 46 by a display module 47. The display module provides control data to the movie decoder module 41 so as to enable decoding at a suitable rate.

The mobile telephone 40 may be arranged to install a loader program from the mobile movie data area 43, if one is stored there. The loader program then causes the mobile telephone 40 to determine its configuration, and to select a media player, which is a software application and which is also stored in the mobile movie data area 43, accordingly. This media player then is used to consume the movie content data. If a suitable media player is already installed in the mobile telephone 40, then this is used instead, and no media player then is installed from the mobile movie data area 43. However, using a proprietary media player stored in the mobile movie data area 43, particularly although not exclusively in the case of the use of a portable storage device such as an MMC, can be advantageous since is allows effective control over the security of the content data, and allows other features not necessarily available with off-the-shelf or pre-installed media players.

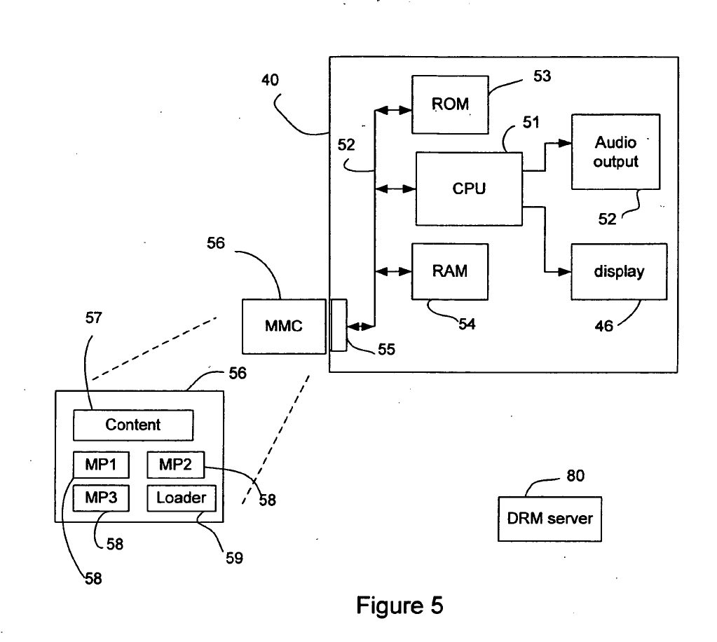

The combination of an MMC and mobile device is illustrated in FIG. 5. Here, the mobile device 40 is shown to include a CPU 51, which provides video signals to the display 46, via a display driver (not shown), and to an audio output device 52 (e.g. headphone socket or speaker, via an audio device driver (not shown). The CPU 51 is connected via a bus to ROM 53, to RAM 54 and to an MMC connector and interface 55. An MMC 56 is connected to the mobile device 40 by the MMC connector and interface 55.

The MMC has stored in its internal non-volatile memory movie content data 57, three different media players 58, and a loader program 59. When content is required to be played-out from the MMC, the mobile device loads the loader program 59, which decides which of the media players 58 is most suitable by determining configuration parameters of the mobile device 40 and comparing them to parameters of the media players. This media player then is selected on the basis of the determination, is loaded onto the mobile device 40, and is run (i.e. the media player program is processed) to reproduce the content from the content data 57. As is conventional, operation of the media player 58 involves storing the media player program in the RAM 54, and using the CPU 51 to extract relevant data from the MMC 56, to decode it and to render the resulting content. The media player 58 removes the obfuscation identifier from the first data content block and adjusts the header, and uses de-obfuscation method to decode properly the content data. FIG. 5 is schematic, and detail not relevant to the invention is omitted.

The or each media player is arranged to detect the properties of the display 46 of the host mobile device 40. In particular, the media player detects the display dimensions and orientation, in terms of numbers of pixels in height and width. The player is arranged to control reproduction of the video content on the display 46 in an orientation which is most suited to the mobile device 40. If the display 46 is wider than it is high, then video content is reproduced with conventional orientation, i.e. without its orientation being modified. If however the display 46 is determined to be higher than it is wide, the media player reproduces the video content rotated by 90 degrees. Thus, the media player ensures that the video content always is reproduced in landscape format (wider than tall) regardless of screen dimensions. This allows more effective use of the area of the display 46.

When the video content is rotated on a display 46 by the media player, the functions of a number of keys on a keypad (not shown) or other input device are caused by the media player 40 to be modified so as to be different to their functions when the video content is not rotated by the media player. Since the mobile device 40 will need to be rotated onto its side before the video can be viewed in its intended orientation, providing different key functions with different orientations allows the same control experience to be provided to a user regardless of the orientation of the mobile device 40. Thus, modifying the controls allows control of the media player using the keypad or other input device to be more convenient and more intuitive for a user. The controls of particular importance are volume up/down, play, pause, forward and rewind, etc.

When the mobile device 40 is not a high specification device, i.e. it has relatively low content handling capability and/or a low resolution display, the media player is arranged such that it can access content from the MMC and not access content from other sources. This allows the content on the MMC to be optimised for reproduction by the proprietary media player, thus providing richer content reproduction than would otherwise be available considering memory size and other technical limitations of the MMC. This feature does not impinge on the ability of the media player to use a standard CODEC 42 pre-existing within the mobile device 40. Indeed, the media player may utilise standard or other third-party CODECs, or it may utilise a proprietary CODEC.

When being run on higher specification mobile devices 40, a different media player 58 is used. Here, the media player selected by the loader program 59 is one which is operable to scale non-optimal content for best presentation.

Alternatively, one media player 58 which has adjustable functionality is provided on the MMC 56. Such a media player does not require a loader program. When running on a mobile device 40, this media player 58 detects the relevant characteristics of the mobile device 40 and activates appropriate components and functionality of the media player 58 and refrains from activating other components and functionality.

The media player 58 includes a seek function. A user can move between chapters in content using the seek function. To allow this, the MMC is written with a placement file, in addition to the media file. The placement file has a file extension “.pm”. It includes a line for each section or chapter. Each line comprises a section name, e.g. ‘start of film’, ‘car chase scene’, etc. Each line also includes a value which relates the timestamp corresponding to the start of that section. The timestamp and the section name are separated by a # character. When a key entry is made on a keypad of the mobile device 40 indicating that it is required to scan to the next section, the timestamp of currently played content is used to identify which line of the placement file relates to the next section. This involves determining the line that includes the smallest timestamp that is greater in value than the current timestamp. The timestamp from this line then is sent to the media player 58. The media player 58 then starts playing content from that timestamp. Since this process is very quick to effect, it will normally have been implemented in less time than it takes for a user to make a second key entry. Thus, sections can be skipped quickly in succession. Sections can also be scanned through in reverse time order.

A digital fingerprint is included at various locations in the content data. The fingerprint for example can be 5 bytes long. The same fingerprint is placed at regular intervals throughout the content data. If obfuscation is used, each occurrence of the fingerprint also is obfuscated. The fingerprints are indistinguishable from the content, so the locations of the fingerprints cannot be determined by examining the data. Thus, a media player which decodes content without first removing the fingerprints will not get the correct data, and playback will fail.

Thus, the media player 58 needs to know what the fingerprint is and where the fingerprints are. This allows content playback to be effected only after authorisation by the server 80. During an authorisation process, the server 80 informs the media player 58 what the fingerprint is and where it is found in the content data. Without knowing where fingerprint is, it cannot be removed from the content by the media player 58. Also, the media player 58 ensures that fingerprint present in the content is as expected before it will play the content. The fingerprint is included in the first packet of the content data, so can be validated straight away.

The use of digital fingerprints allows some advantageous features.

For example, an MMC can be sold with one media item (e.g. a movie or TV show) unlocked for playback by the media player 58. Other media items are provided on the MMC, but need unlocking before they can be played. In the menu of the media player 58, the additional media items are shown as being locked. When one of these media items is selected, the media player 58 causes a media code to be displayed for that media items, and provides an entry window in which an unlock code can be entered.

To unlock the media item for playback, the user of the device 40 sends an SMS to the server 80 which includes the media code displayed by the media player 58. The media code is 11 bytes (i.e. 11 alphanumeric characters) long. It is comprised of an obfuscated message including a media identification code, which identifies the corresponding media item, and the serial number of the media player 58. On receiving the media code via SMS, the server 80 validates the code. Validation involves checking that the serial number relates to a media player 58 which exists, and checking that the media item exists. Once validated and once the media item is known to be paid for, the server 80 obtains a suitable unlock code, obfuscates it and sends the obfuscated unlock code to the device 40. The unlock code includes the serial number of the media player 58 and the digital fingerprint which is included in the content data. Payment can occur through a WAP push SMS, which takes a WAP browser of the device 40 to a payment system such as Bango or mwallet. Following the server 80 receiving confirmation of payment from the payment system, the unlock code is sent by SMS from the server 80 to the device 40. Alternatively, the server 80 could send a reverse billing SMS containing the unlock code, which the user is billed for by their mobile telephone service provider.

Alternatively, this could be done automatically using an http connection, on selection of a “buy” option by a user.

On receiving the SMS, the user enters the received obfuscated unlock code included in it into the entry window provided by the media player 58. The media player 58 then de-obfuscates the unlock code, and checks that the serial number forming part of the unlock code matches the serial number of the media player 58. A suitable message is displayed if there is not a match, since the user may have entered the unlock code wrongly. If there is a match, the media player writes the unlock code, including the digital fingerprint included in, it into the MMC, to unlock the media item. To play the media item, the user then accesses it through the menu provided by the media player 58. The media player 58 then accesses the unlock code from the MMC, which allows the media item to be played if the fingerprint in the unlock code is the same as that included within the content data.

If the fingerprint in an unlock code does not match the fingerprint present in the content, the media player 58 is arranged to delete any unlock code for that media item from the MMC, and revert to the menu. This allows operation of the media player 58, and the possibility of entering the correct unlock code, even if the unlock code entered into the MMC is wrong, for example because it was entered in respect of the wrong media item.

An optional additional feature ties the MMC to a particular device using the IMEI of the device. When first installed on a device and before registration, the media player 58 knows the serial number of the content, and knows the media identification code, but does not know the digital fingerprint. The fingerprint is needed before the content can be played. The media player 58 initiates an http connection to the server 80. The media player 58 then registers by submitting the serial number of the media player 58 and the IMEI number of the device 40 to the server 80. The server 80 looks-up the content identifier on the basis of the received information, and stores the received information. The server 80 then sends an encrypted message comprising the IMEI, the serial number of the media player 58, the fingerprint and information identifying the locations of the fingerprint in the content. The media player 58 stores the encrypted message on the MMC. The media player 58 then is able to play the content. If the MMC then is moved to another device 40, which necessarily will have a different IMEI, it will not be played by the media player 58. In particular, when the media item is selected to be played, the media player 58 checks the serial number, the media identification code and the IMEI forming part of the encrypted message stored on the MMC. The media player 58 is arranged such that if the IMEI stored as part of the encrypted message does not match the IMEI of the device 40, the media player 58 will not play the content. To enable the content to be played on a different device 40, the content must first be unregistered from the original device. It may then be registered on the new device 40 in the manner described above. Additional media items on the MMC can be purchased in the same way as that outlined above. Furthermore, different media items may validly be registered onto different devices, as long as each media item is registered only onto a single device 40.

If content stored on an MMC is allowed to be copied freely by users, this technique can be used to track copies. Here, deregistration is not required. An MMC can be registered successively onto different devices 40. Furthermore, there can be an unknown number of copies in existence. When an MMC is loaded onto a device which has not been registered for the content, the media player 58 contacts the server 80, which registers the content. Following registration, the server 80 sends to the device 40 the encrypted message which allows it to play the content. By monitoring registrations, the server 80 can determine how many copies of the MMC are made. The server 80 can also determine an approximate geographical distribution of them by detecting the gateway IP address of the network element through which the content is registered.

The hardware of the MMC 56 may be standard, for example any of the MMC forms which currently are publicly available. A typical MMC hardware design consists of a flash memory device and a memory/interface controller residing on a very thin PCB (printed circuit board) in a very low profile plastic housing. The underside of the PCB generally forms the bottom of the housing. There are a number of different sizes of MMC.

According to certain aspects of the invention, the MMC hardware is non-conventional, and includes additional security features. In this case, a proprietary media player 58 is used to unlock and read content on the secure MMC.

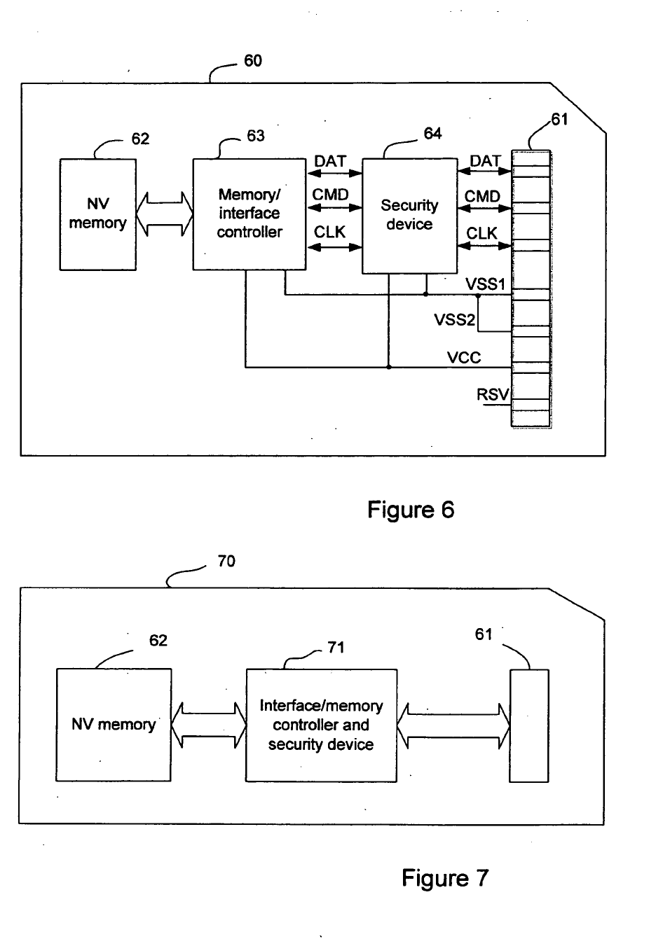

A first embodiment of a novel. MMC will now be described with reference to FIG. 6. Here, an MMC 56 includes a housing 60 in which connector pins 61 are provided. The connector pins form part of a host communications interface to an external device, such as the mobile device 40. The MMC 56 also includes non-volatile memory 62, connected to a memory and interface controller 63, which controls access to the memory 62 and interfaces to the connector pins 61. The MMC thusfar described is conventional. The MMC 56 also includes a security device 64, which is not conventional. The security device 64 is interposed between the memory and interface controller 63 and the connector pins 61. Thus, the memory and interface controller 63 and the data (DAT), command (CMD) and clock (CLK) ones of the connector pins 61 are not connected directly since at least some connection between these components is via the security device 64. VCC, VSS1 and VSS2 ones of the connector pins 61 are connected to both the security device 64 and the memory and interface controller 63 in parallel. The security device 64 may be implemented as a microcontroller, an ASIC (application specific integrated circuit) or an FPGA (field programmable gate array). The components of the MMC 56 are mounted onto a PCB (printed circuit board), which forms part of the housing 60. Thus, the MMC 56 may have the same dimensions and the same external connectors as a conventional MMC.

The security device 64 is arranged to intercept data and commands communicated between the host device, e.g. the mobile device 40, and the memory and interface controller 63. This intercepted data is processed and either is passed through the security device 64 modified or unmodified, or alternatively is replaced by data generated by the security device 64 itself.

Specific data or commands passed in any response can switch the security device 64 into an active mode, in which the security device 64 reads or writes to one of the memory and interface controller 63 and the host interface 61, masquerading as the other one of those devices. In the active mode, the security device 64 also independently, i.e. without external control, interrogates the memory and interface controller 63 and either prepares data for subsequent host requests or writes data to the non-volatile memory 62 for subsequent requests.

The provision of the active mode allows copy protection to be achieved through cooperation between the MMC 56 and the media player 58.

The security device 64 does not restrict access to regions of the non-volatile memory 62 where unprotected content resides, in both read and write modes. This allows the MMC 56 including the security device 64 to be used conventionally, i.e. without the security features provided by the security device being operational. The security device 64 can be activated only by authorised entities, such as those licensed to place copyright content, e.g. movies, onto the MMC 56.

The MMC 56 and the media player 58 are provided with the same serial number. During configuration, the media player 58 is provided also with the result of application of the derail number to a hash function, hereafter termed the hash of the serial number. The memory and interface controller 63 is controlled by the security device 64 to store at programming time (i.e. when it is programmed before sale) the serialised data serial number, a preconfigured security code, and the hash of the serial number.

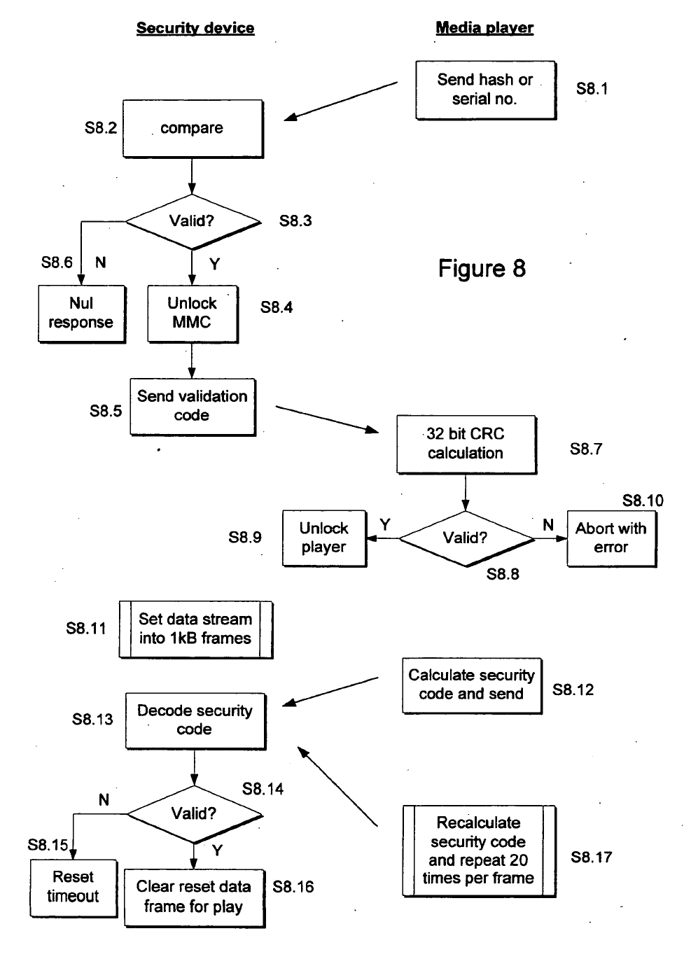

Validation of the MMC 56 by the media player 58 and validation of the media player 58 by the MMC 56 will now be described with reference to FIG. 8.

When the MMC 56 with content, one or more media players 58 and optionally a loader program 59 loaded onto it is connected with a mobile device 40, the media player is made visible in a menu thereof, and thus becomes able to be activated as with any other software application present on the mobile device 40. When the media player 58 first is started, a first security validation is implemented, in which the following occurs. Firstly, the most suitable media player 58 is uploaded to the mobile device 58. The media player 58 then at step S8.1 sends the hash of the serial number to the security device 64. The security device 64 at step S8.2 then compares this with its internally stored hash of the serial number. If the comparison at step S8.3 reveals a match, it is initially assumed that the media player 58 and the MMC 56 are matched, and the security device 64 unlocks the MMC 56 at step S8.4. The security device 64 then sends at step S8.5 the preconfigured validation code to the media player 58. Alternatively, if the comparison does not reveal a match, the security device 64 at step S8.6 does not respond. When the media player 58 receives a validation code, it performs at step S8.7 a 32 bit CRC (cyclic redundancy check) calculation on the validation code. On the basis of this calculation, the media player 58 determines at step S8.8 whether the MMC 56 is the one associated with the media player 58, and unlocks the media player at step S8.9 if appropriate, or else aborts with an error message at step S8.10. At this stage, the media player 58 can read data from unprotected areas on thereon-volatile memory 62, if any such areas are present.

A second stage security check is performed when playing the content. After the media controls on the MMC 56 are unlocked and the data becomes readable, data is read out from the non-volatile memory 62 to the media player 58. In parallel with this, the data stream is set at step S8.11 into frames of 1 kB, i.e. there are 1000 bytes between frame start and end points. The media player at step S8.12 calculates the security code (as described in more detail below) and then sends it to the security device 64, where it is decoded at step S8.13. On the basis of the decoding, the security device 64 determines at step S8.14 if the security code is valid. If invalid, the security device 64 at step S8.15 resets a timeout counter, thereby preventing a timeout occurring and locking the content. If valid, the memory and interface controller 63 at step S8.16 considers the subsequent data frame as being validated for access. If a valid code is not received before the end of this frame, subsequent frames are filled with random data instead of content data.

The media player 58 recalculates the correct security code once in every frame, but generates 20 security codes for each data frame, 19 of which are incorrect. The media player 58 sends the MMC 56 all the security codes at step S8.17, in this example resulting in 20 security codes being sent for every frame of data. 19 of these codes are intentionally incorrect, and only one of them is correct. The security device 64 of the MMC 56 compares the results of its calculations with the security code sent by the media player 58. The security device 64 allows content data to be sent to the player as long as one correct security code is received in every frame. If the security device 64 detects that a valid security code has not been received for a predetermined period of time, using a timer, or if too few codes (either correct or incorrect) are received, then the security device 64 disables access to the data in the non-volatile memory 62. The security device 64 then needs to be unlocked again by the media player 58 before content playback can be resumed.

The security device 64 also locks the MMC 56 if it has not been accessed for a predetermined, configurable period of time.

The security code is calculated based on the following data:

CRC—the last 4 bytes of the decoded validation code (the checksum part)

Bytes—the total number of bytes read from the MMC 56 so far

Random—a number between one half of the number of security updates per frame (in this case, 10 is half of the 20 updates per frame that there are) and 0.

The media player 58 performs the calculation:
((CRC<<Mod 32(Bytes))Xor(Bytes))*Random

This means that the checksum part (CRC) of the validation code is shifted left by a modulo of 32 of the number of bytes read. The result is Xor-ed with the number of bytes read. The Xor operation consists of applying corresponding bits in the two numbers to respective exclusive or gates. The result is multiplied by the random number Random.

The security device 64 in the MMC 56 performs the calculation:
((CRC<<Mod 32(Bytes))Xor(Bytes))*Moduloframe size(frame number)

Moduloframe size(frame number) is frame number modulo 1000 in this instance because the frame size may change, i.e. 1000 e.g. 5032 becomes 0032.

The result of this is the continual validation of the media player 58 by the security device 64 of the MMC 56. This prevents it being possible to use a false media player to extract the content data in a useable form; instead the data can only be extracted from the MMC 56 by the correct media player 58, which renders the content for consumption but does not allow the content data to be used to provide unauthorised copies. The fact that the media player 58 sends many incorrect codes makes it difficult or impossible to determine from examination of the codes sent from the media player 58 to the MMC 56 what calculation is needed to determine the correct codes, thus increasing security since the difficulty of making a false media player which could extract data from the MMC is significantly increased.

Using these features, the security device 64 is operable to determine whether an external device, comprising the mobile device 40 running the media player 58, is entitled to access content data from the non-volatile memory 62, and to allow or disallow access to the content data accordingly.

An alternative MMC 70 is shown in FIG. 7. Here, the memory and interface controller 63 is omitted. Instead, a combined memory and interface controller and security device 71 connects the non-volatile memory 62 with the connector pins 61. This provides the same functionality that the memory and interface controller 63 and the security device 64 do together, but with some additional functionality, as explained below. This embodiment has an advantage in that it could be included within a smaller housing than the FIG. 6 MMC 56. Since it has less hardware, it may also be less expensive to manufacture. Also, the combined memory and interface controller and security device 71 does not need to support the same type of non-volatile memory as a MMC controller, thereby providing component flexibility.

The combined memory and interface controller and security device 71 emulates the host interface of a standard MMC controller, so as to allow full connectivity with host devices, such as the mobile device 40. It also supports additional host interface commands to support security configuration and security validation in some specific hosts. The combined memory and interface controller and security device 71 encrypts all data written to the non-volatile memory 62, and decrypts all data read from the non-volatile memory 62. Thus, data accessed by the mobile device 40 is not read from the non-volatile memory 62 directly; instead it is decrypted, processed and buffered in the combined memory and interface controller and security device 71.

Some data accessed by the host is a result of processing, for example the security device 64 compiles information for subsequent host requests, or is status information, e.g. security status information, which the media player 58 can use to re-validate security or inform the user of the nature of a problem

The combined memory and interface controller and security device 71 can be implemented by a microcontroller, an ASIC or an FPGA.

With the MMCs of both FIGS. 5 and 6, DRM information is stored in a DRM file within an area of the non-volatile memory 62 which has been defined as a secure area during MMC configuration. The media player 58 can read the DRM file but not influence it, except in the case of a time specific DRM matter. The security device 64 or 71 is arranged to count the number of times that the content is played. If the content is only partially played, this is counted as a play of the content. The number of times that the content has been played is recorded in the DRM file by the security device 64 or 71. This information can be read by but cannot be not influenced by the media player 58. The DRM file indicates a maximum number of occasions in which the content data can be played out.

The DRM data also includes a timeout date or validity date for the content. When the media player 58 is first started, it cooperates with the security device 64 or 71 to write the current time and date of the mobile device 40 from its internal clock (not shown) into the DRM file. If playback of the content is requested and the security device 64 or 71 determines that the latest time and date at which the content could be played has expired (i.e. the current time and date is later than the time/date first recorded plus the validity period), the security validation between the security device 64 or 71 and the media player 58 fails, and an appropriate message is delivered to the user via the display 46. The same occurs if the limit of the number of occasions on which the content data can be played out is reached. The security device 64 also writes to the DRM file data identifying that the content has expired.

If after the content has expired once and the time/date of the mobile device 40 is changed to a value that precedes the expiry time/date of the content, the security device 64 or 71 can detect this by detecting data identifying that the content has previously expired in the DRM file. In this case, a predetermined number of further plays of the content, for example 5 plays, are allowed before the content becomes locked requiring a DRM unlock. This is achieved using on-line validation. This feature eases the user impact if the clock in the mobile device was incorrectly configured when the media player 58 was first started.

The on-line validation process commences with the media player 58 connecting to a DRM server, shown at 80 in FIG. 5, for example belonging to an entity that is licensed to render content onto MMCs. The DRM server 80 knows the configuration of every MMC 56 that has been released. Connection may be made through WAP or SMS, or in any other suitable way. If the DRM information on the DRM server is valid, the DRM server sends a code through the media player 58 to the security device 64 or 71, which causes it to be validated and thus unlocks the content for further playback. This involves updating the DRM file. Locked content can be unlocked again by payment for further content access through a variety of channels (web, wap (e.g. Bango) and SMS).

If content on an MMC 56, 71 is locked, the media player 58 will not play the content data back. In this case, the user of the mobile device 40 may arrange for the content to be unlocked for further playback, for example by making an additional payment. This can occur in any suitable way, for example using WAP, a web-based payment service, or by negotiating with an operator by telephone. When payment is made, the DRM server 80 is updated with this information. When the user subsequently starts the media player 58 and attempts to access the locked content, the media player 58 contacts the DRM server 80, in any suitable way, which sends an unlocking code to the mobile device 40 which the media player 58 passes to the security device 64 or 71. The security device 64 or 71 then validates the unlocking code, and updates the DRM file to unlock the content. This may involve the use of digital fingerprints, as described above.

If an MMC 56 such as one of the FIGS. 6 and 7 MMCs 60, 70 is used, some high-level protection is possible through suitable design of the MMC hardware. Circumvention of such protection would require reverse engineering of the media player 58.

Broadly speaking, certain sectors of the MMC 56 are arranged not to contain correct data (and hence not correct “next sector” data) until specific data has been read and written from other, specific, sectors on the MMC 56. Some of the media player 58 system files and part of the content will reside over some of these sectors. This copy protection implementation consists of custom MMC hardware implementation, MMC build tool functionality (special format etc), and support by the media player 58 (which must write and read the right security sectors).

At start-up of the media player 58 and at regular intervals thereafter, the media player 58 writes specific data to some unused sectors on the MMC 56. These sectors are unused because the format of the file system on the MMC 56 (as specified by the boot sector) does not include these sectors. The data written to these sectors is processed by the MMC 56, and the result is reflected in a number of file sectors. The result is the correct data for the sector.

In particular, specific data areas on the MMC 56 contain data that is a result of an algorithm applied to data written to other areas of the MMC 56. For instance, this could be a combined hash function of 10 writes to another block of a smaller size. E.g. from 15360 to 15871 bytes on the MMC 56 is calculated by a hash generated from data written to bytes 15360 to 15871 over 10 consecutive correct writes. This calculation places expected content in bytes 12800 to 13311. This block will be a sector in a file that the media player 58 is about to read from. Importantly, the next sector in the file is referenced from this sector. The media player 58 is arranged such that, if this sector does not contain correct data when accessed by the media player 58, the media player will shutdown (and may even crash).

Some of these writes generate garbage content in the read area, and some of the writes generate genuine content that the media player 58 will use. Because the media player 58 writes many times, most of the time with bogus information, deciphering of this process is time consuming and a good deterrent against copying. Thus, this is effective in significantly hindering reverse engineering techniques.

An example of this is as follows. Three sectors on the device, each of 512 bytes, are target sectors that are referenced as part of a file on the MMC. These target sectors contain the results of calculations on the data contained in source sectors. Nine source sectors, each of 512 bytes are used.

Accordingly, three source sectors are processed per target sector. An example calculation is as follows: the first target sector is contains all of the bytes of source (unsigned calculation) sector1(1^{st} byte to last)+source sector 2(1^{st} byte to last) xor source sector 3 (last byte to 1^{st})

Source sector 1 resides on block 12034, 2 on 12044, 3 on 12054, 4 on 12035, 5 on 12045, 6 on 12055, 7 on 12036, 8 on 12046, 9 on 12056

Target sector 1 is associated with source sectors 1, 2 and 3, and resides on sector 8000. Target sector 2 is associated with source sectors 4, 5 and 6, and resides on sector 8001. Target sector 3 is associated with source sectors 7, 8 and 9, and resides on sector 8002.

The resource file for the media player 58 resides across target sectors 1, 2 and 3, and content resides over 5, 6, 7, 8 and 9. Reading these files without writing the correct information into the source sectors will result in file corruption.

Although the mobile device 40 is said to be a mobile (cellular) telephone, it may instead be a personal digital assistant (PDA), which may or may not have bidirectional voice communication capabilities. The invention is primarily concerned with providing audio-visual content on a device which is designed primarily for another function. However, the invention is concerned also with dedicated media players.

Also, although certain aspects of the invention have been described in relation to an MMC 56, this is not essential. Instead of an MMC, other type of medium including non-volatile memory and an internal memory controller with access to content data stored on the memory being obtained through an interface could be used instead. For example, a memory device with a USB or Bluetooth™ or other interface could be used instead. The housing of the memory device may take any suitable form.

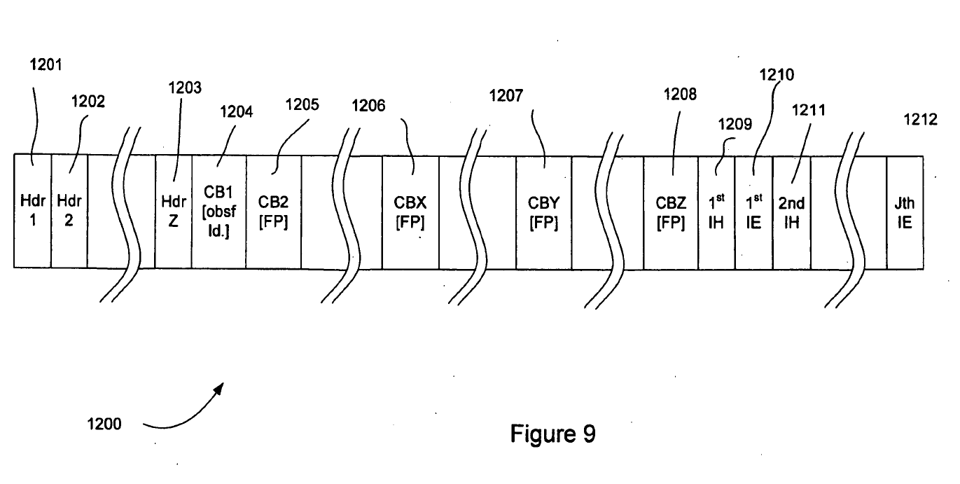

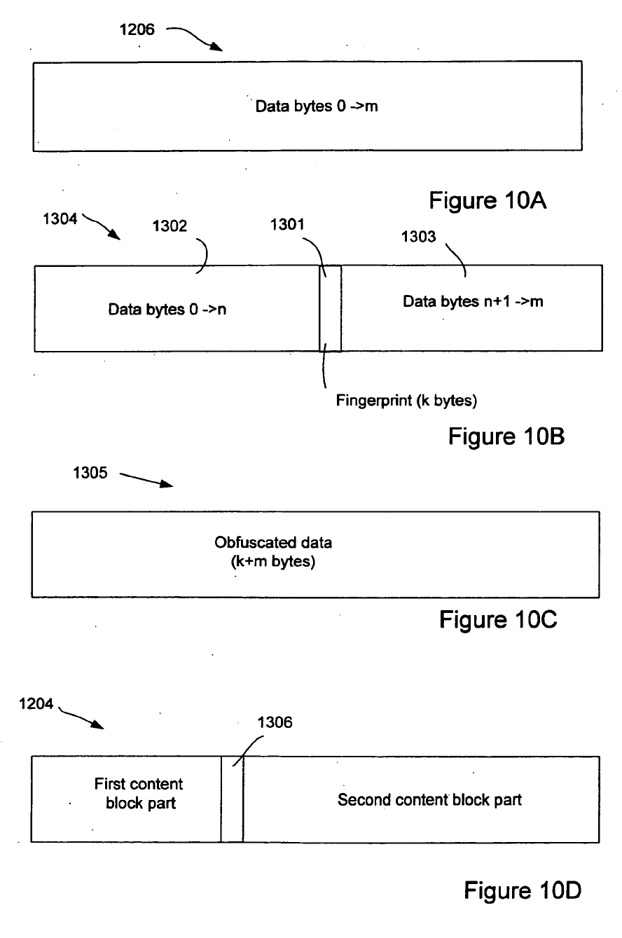

An alternative scheme for protecting the content stored on the MMC using digital fingerprints and obfuscation will now be described with reference to FIGS. 9, 10A, 10B, 10C and 10D.

FIG. 9 illustrates a sequence 1200 of data packets stored on the MMC. First in the sequence 1200 are first to Zth headers, of which the first, second and Zth headers 1201, 1202, 1203 are shown. Immediately after the Zth header 1203 is a first content block 1204, which is the first of Z content blocks in sequence. The first, second, Xth, Yth and Zth content blocks 1204, 1205, 1206, 1207, 1208 are shown in the Figure. The headers each have a one-to-one relationship with a respective content block, and are in the same sequence, i.e. the Sth header relates to the Sth content block.

Following the Zth content block 1208 is an index section, which comprises first to Jth index headers and first to Jth index entries. A 1^{st} index header 1209 if followed by a 1^{st} index entry 1210, which is followed by a second index header 1211 etc. An index header thus is immediately followed by the index entry to which it relates. The final data is a Jth index entry 1212. Typically, J is a number much smaller than Z.

Each of the content blocks 1204-1208 relates either to audio or video content. Each content block includes a timestamp, so that a media player can relate audio content to the corresponding video content. The header of a content block 1204-1208 includes information which identifies which stream the content block relates to. In most cases, there will be only one audio stream and only one video stream, although this may vary.

In this example, the content blocks are produced by a RealProducer tool, so the headers 1201-1203 and the data in the content blocks 1204-1208 are compliant with the Real format. The content is decodable by a Real codec. Real is a trademark of RealNetworks, Inc. With Real, each content block 12045-1208 which relates to a video stream contains data relating to a whole video frame. Thus, each content block includes all the information relating to a frame, and relates to only one frame. A key frame is provided periodically, and each non-key frame between successive key frames detail differences between the previous frame and that frame. The interval between successive key frames is a settable parameter in RealProducer. The size of content blocks is variable. Where there is a lot of difference between two successive frames, the content block for the second frame includes a relatively large amount of data. Where there is less difference, the second frame typically contains less data. Where there is no difference between successive frames, the second content block may contain only a few bytes of data. Each header 1201-1203 includes information which identifies whether or not the corresponding content block 1204-1208 includes data of a key frame.

It is not possible for a machine or human operator to determine from examining the data of the content blocks 1204-1208 where the boundaries between the content blocks lie. However, each of the content headers 1201-1203 includes data which indicates the length in bytes of the corresponding content block 1204-1208. Thus, the start address of a content block 1204-1208 can be determined by adding the start address of the previous content block the length of the previous content block and one additional byte. Adding the length of the previous block to the start address of that block results in the address of the final byte of that block, thus the start address of the following content block is found by adding an additional byte to that address.

Thus, if any bits or bytes are added or taken away from any of the content blocks 1204-1208, the actual start addresses of all following content blocks will not match the addresses calculable from the headers 1201-1203. In this event, the data fed into a Real decoder will not be decoded properly, and the media player would probably stop working altogether and require closing and reopening before it could become operational.

The inventors exploit this to advantage. In particular, some content blocks 1204-1208 are each provided with one or more excess data items. The excess data item preferably is a digital fingerprint. In the Figure, the 2nd, Xth and Yth content blocks 1205, 1206, 1207 are provided with a digital fingerprint.

It clearly is important for a media player which is to playback the content to know where the excess data items are. Otherwise, data sent to a decoder in the media player may not be in the correct format, and thus will not be decoded properly and may crash the media player.

There are numerous ways in which a media player can be informed of the locations of excess data items in content data. The inventors have found that a particularly good solution is to utilise a pre-determined scheme to determine where to include excess data items before recording the data onto the MMC, and to program the media player with details of that scheme.

In some embodiments, excess data items are included in the second content block 1202 and at regular intervals (in a playback or presentation time sense) thereafter. For instance, excess data items can be included in the first content block having a timestamp immediately following an integer multiple of a predetermined excess data item interval, for instance 20 seconds. According to this technique, excess data items are included in the first content block having a presentation time after 20 seconds, in the first content block having a presentation time after 40 seconds, the first content block having a presentation time after 60 seconds and so on.

The location of the excess data within the content block 1205-1207 also is important. In some embodiments, the excess data items are included at the same position in each of the content blocks 1205-1207 in which it present. For instance, the excess data may be included from byte 56 of those content blocks 1205-1207. Bytes 57 onwards of the content block are retained, but after the digital fingerprint. If a content block includes 56 content blocks or fewer, then the excess data items are included at the end of that content block, after all of the content data. Thus, if a content block includes 20 bytes, then the excess data begins at the 21^{st} byte.

There are numerous ways in which a media player can be informed of the locations of excess data items in content data. The inventors have found that a particularly good solution is to utilise a pre-determined scheme to determine where to include excess data items before streaming the data, and to program the media player with details of that scheme.

For instance, there may be twenty different schemes that the media player is programmed to handle. Each scheme is identified by a different digital fingerprint scheme identifier. This may form part of the media code, may be included at a suitable location in the content, similarly to the obfuscation identifier, or may be identified to the media player in any other suitable way. A first scheme may involve digital fingerprints included at byte 56 in each of the first content blocks following integer multiples of 20 seconds, as described above. A second scheme may involve including a digital fingerprint at byte 32 of every content block immediately following integer multiples of 30 seconds. A third scheme may involve including a digital fingerprint at byte 32 of the content block six content blocks following integer multiples of 30 seconds. A fourth scheme may involve including a digital fingerprint at byte 32 of every content block immediately following integer multiples of 60 seconds and at byte 11 of every content block immediately following integer multiples of 30 seconds unless there is a digital fingerprint at byte 32 thereof, i.e. the location of the digital fingerprint alternates between byte 11 and byte 32 between successive occurrences of it. In another scheme, the content block in which the fingerprint is located is varied. For instance, the digital fingerprint may be located relative to a content block immediately following integer multiples of 40 seconds, at three content blocks following, seven content blocks following and two content blocks following in a repeated sequence. The more the location of the digital fingerprint is varied, the greater the protection that is afforded.

The length of the excess data items are not critical, although to avoid increasing the size of the resulting data by a significant degree the excess data preferably is not unduly long.

Since the excess data items are intended to be removed before decoding, the form (i.e. content) of the excess data items are not necessarily important. However, the inventors prefer that the excess data items are in the form of a digital fingerprint. Preferably, each occurrence of the digital fingerprint is the same, i.e. has the same data sequence. For instance, the digital fingerprint may be 5 bytes long. Even if a third party manages to determine the data constituting the digital fingerprint, data strings having the same data will be present at numerous locations in the content data, so this information alone would not be enough to allow the digital fingerprints to be removed.

A content block, for instance the Xth content block 1206, is shown in FIG. 10A. The content block 1206 includes m bytes of data. In FIG. 10B, the content block 1206 is shown with a digital fingerprint 1301 added, and is labelled 1304. The digital fingerprint 1301 separates the m data bytes into two sections 1302, 1303. The first section 1302 includes data bytes 0 to n, and the second section 1303 includes data bytes n+1 to m. The length of the content block with the fingerprint is equal to m plus k bytes, where k is the size of the digital fingerprint. Using the example given above, n is 56 and k is 5.

To provide additional protection against unauthorised playback and/or copying, some or all of the content blocks are obfuscated before they are stored on the MMC. Where a content block includes an excess data item, such as a digital fingerprint 1301, then the excess data item is obfuscated along with the data forming the original content block. Simply, obfuscation comprises altering the data so that the resulting obfuscated data is different to the original data and cannot be decoded properly without first being deobfuscated. Obfuscation typically does not alter the amount of data, so the size of a content block is the same before and after obfuscation. Obfuscation is discussed above in relation to FIG. 3. The content block 1304 including the digital fingerprint 1301 is shown obfuscated at 1305 in FIG. 10C. The obfuscated content block 1305 includes k plus m bytes, as with the digitally fingerprinted content block 1304.

The first content block 1204 is extended with an obfuscation identifier 1306, as shown in FIG. 10D. The obfuscation identifier 1306 is located at a suitable position in the first content block 1204, and the corresponding content header 1201 is adjusted to reflect the length of the content block including the obfuscation identifier 1306. The obfuscation identifier 1306 identifies what obfuscation method was used by the DRM processing module 21 to obfuscate the data. This allows a suitable media player it to perform the corresponding de-obfuscation method. Following addition of the obfuscation identifier 1306, it may be necessary to correct affected index entries so that seeking can be performed properly. The first content block 1204 is not obfuscated, since otherwise the obfuscation identifier 1306 would be obfuscated.

If only one obfuscation scheme is used with all content, then the media player 58 knows what obfuscation is used, and thus the obfuscation identifier 1306 can be omitted from the first content block 1204.

Since the content blocks 1203-1208 which include a digital fingerprint include more data than is indicated by their corresponding header 1201-1203, the index entries 1210, 1212 would be incorrect. In particular, the physical addresses pointed to by data forming part of the index entries 1210, 1212 are supposed to point to the address of the beginning of key frames. However, if a digital fingerprint is included in one or more content blocks preceding that key frame, the actual address of the beginning of the content block containing key frame data will be higher than the address indicated by the corresponding index entry 1210, 1212. Accordingly, the data in the index entries 1210, 1212 is modified to reflect correctly the actual start addresses of the content blocks that the data is intended to correspond to. Thus, when the data of the index entries 1210, 1212 is used by the media player 58 to access content, the content is decoded and played back correctly.

Following obfuscation of some or all of the content blocks 1205-1208, the provision of a suitable obfuscation identifier 1306 in the first content block 1204 and the modification of the data in the index entries 1210, 1212, the resulting data is stored on the MMC 56.

When the MMC 56 is inserted into a mobile device 40, the mobile device 40 loads the media player 58. When an item of content is selected for playback by a user through a menu of the media player 58, the media player 58 begins to read the headers and the content blocks relating to that content. The DRM validation module 44 within the media player 58 knows the location of the obfuscation identifier 1306 within the first content block 1204, and extracts it. The DRM validation module 44 of the media player 58 then uses the obfuscation identifier 1306 to determine what obfuscation method is needed to de-obfuscate the content data 57. The DRM validation module 44 also determines whether the media code needed to playback the content data 57 is present. During an authorisation process, the server 80 provides the media code to the media player 58. The media code also identifies the digital fingerprint 1301, and allows the media player 58 to determine in which content blocks 1205-1208 and where in those content blocks the digital fingerprint is present. This can occur in any suitable way. For instance, the media code may include a digital fingerprint location code, which identifies a predetermined scheme useable to remove the occurrences of the digital fingerprint. The media player 58 then is ready to playback the content. However, the media player 58 preferably is arranged to playback the content only if the digital fingerprint included in the content blocks is the same as the digital fingerprint included in the media code. This provides a further check that the user is entitled to playback the content using the media player 58. The fingerprint is included in the second content block 1205, so can be validated straight away after playback of the content is commenced.

Without knowing where fingerprint is, it cannot be removed from the content by the media player 58. Also, the media player 58 ensures that fingerprint present in the content is as expected before it will play the content.

In playing back the content, the DRM validation module 44 de-obfuscates those content blocks which are obfuscated. For instance, in respect of the content block 1305 of FIG. 10C, the DRM validation module 44 performs the inverse of the obfuscation performed at the DRM processing module 21, thereby obtaining the fingerprinted content block 1304. In playing back the content, the DRM validation module 44 also removes fingerprints from the content blocks that include them. For instance, in respect of the content block 1304 of FIG. 10B, the DRM validation module 44 removes the digital fingerprint 1301, thereby obtaining the content block 1206 shown at FIG. 10A. The content blocks are fed to the codec 42 of the media player 58 only after de-obfuscation and after removal of the digital fingerprints. Failure to do either of these actions would result in incorrect data being fed to the codec 42, likely resulting in the crashing of the media player 58. At best, content would not be played back in a useable form.

If a media player other than the media player 58 is used to attempt to playback the content, it will fail. In order to construct a media extractor which could extract useable content, the media extractor would need to know exactly what obfuscation method to use, and exactly where in the content blocks the excess data items are and what size they are. Thus, this technique provides substantial protection against unauthorised use of the content. Even with a relatively simple obfuscation method and relatively infrequent digital fingerprint inclusion, the protection afforded is such that it is technically more straightforward to extract content from an encrypted DVD than it is to take content from the MMC 56. Since the media player 58 knows what de-obfuscation method is used and from what locations the digital fingerprint needs to be removed, it can playback the content correctly. However, the media player is not a media extractor, so cannot be used to extract the content in unprotected form for unauthorised use.

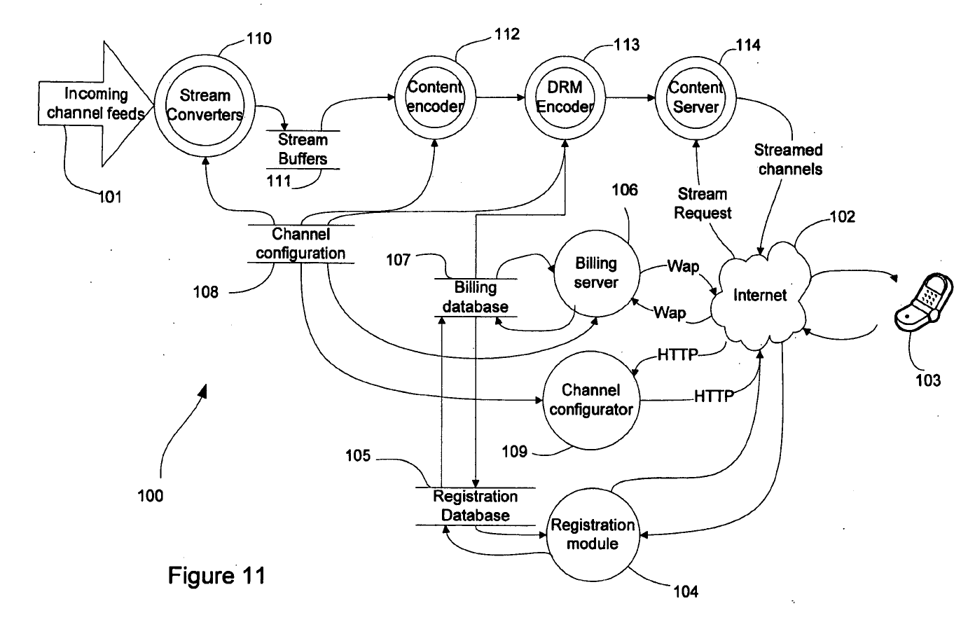

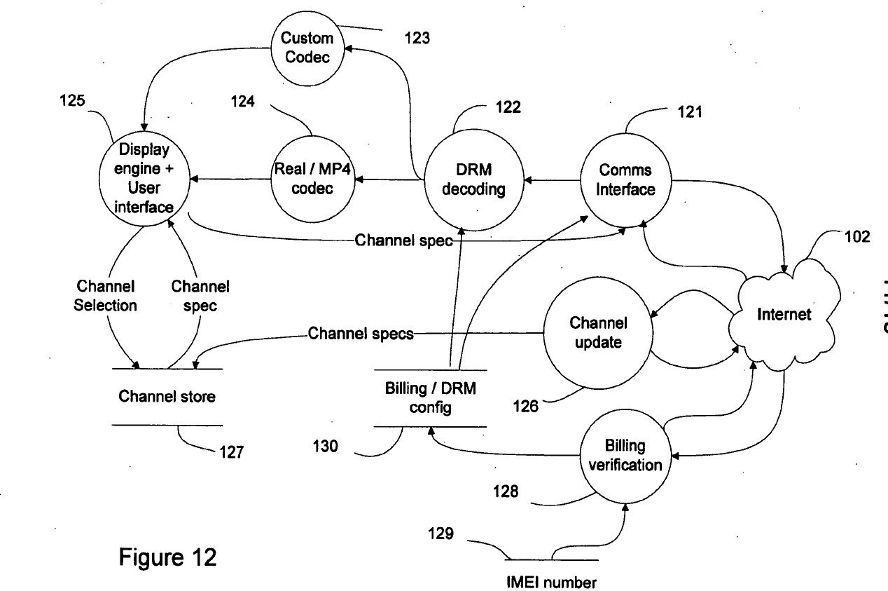

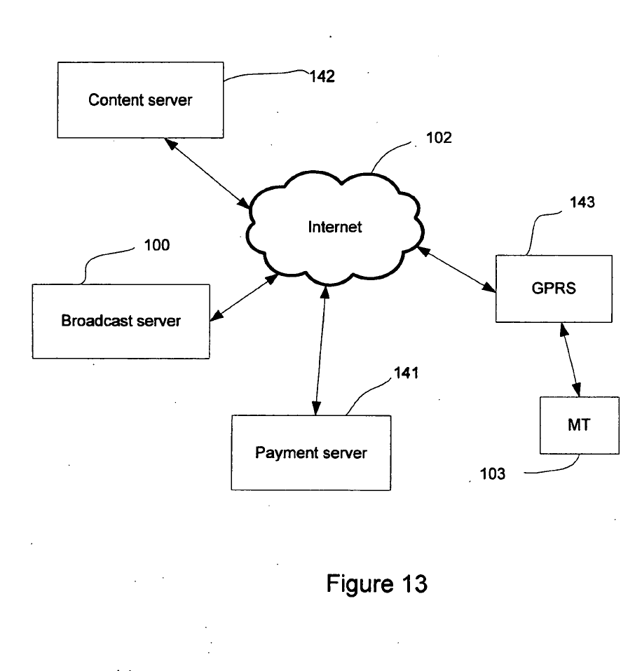

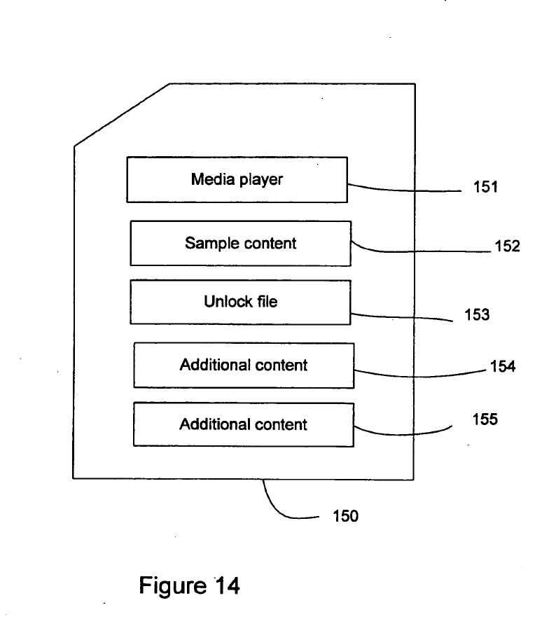

The use of digital fingerprints and obfuscation is useful in protecting transmitted content aswell as content stored on a carrier. An overview of a broadcast television and radio system will now be described with reference to FIGS. 12 and 13. Referring to FIG. 11, a broadcast server 100 includes an input 101 at which channel feeds are received, and input/outputs to the Internet 102. A mobile terminal 103, for instance the mobile terminal 40, is connected to the Internet 102 through a mobile network (not shown), and thus is able to communicate with the broadcast server 100. Briefly, once a user of the mobile terminal 103 has subscribed to broadcast services, they are able to request streaming to them of data through which they can view a television channel or listen to a radio channel using the mobile terminal 103.

The broadcast server 100 includes a WAP registration module 104, through which a user of the mobile terminal 103 can become registered with the broadcast server 100 through a WAP connection to the Internet 102. The mobile terminal 103 may be identified for example by its IMEI number. The registration module is in two-way communication with a registration database 105, which maintains details of registered users and which allows a supervisor to monitor registered users and to unregister them as required. Following registration, the user is able to subscribe to services using a WAP connection between a billing module 106 and the Internet 102. The billing module 106 is in two-way communication with a billing database 107, which monitors subscriptions and allows a supervisor to examine individual subscriptions and to provide subscription statistics. The billing database 107 and the registration database 105 are in two-way communication with one another, so that registration information can be passed to the billing module 106 and subscription and billing information can be passed to the registration database 105 and the registration module 104.

A channel configuration database 108 maintains configuration parameters of channels between the broadcast server 100 and multiple mobile terminals, only one of which is shown at 103 in the Figure. Channel configurations are passed from the configuration database to a channel configurator 109, which has an http connection to the Internet 102 The channel configuration database 108 contains configuration data for the channels. The channel configuration database 108 is updated using a web based administration tool to add, modify and remove channels to conform to incoming streams, which are setup by a manual configuration process.

The data included in the channel configuration database 108 consists of the full URL of each channel.

The channel configurator 109 reads the channel configuration database 108, prepares an XML list of all channels available to a particular user (i.e. the channels to which they have subscribed) and sends this XML list to the media player 58 on the mobile device. A menu option to “refresh channels” within the media player can be used to initiate this process. The media player then creates a new channel list for the user.

Data received at the channel feeds input is processed by a chain of components comprising stream converters 110, stream buffers 111, a content encoder 112, a DRM encoder 113 and a content server 114. In this example, the streamed content is in Real™ format, so the content encoder 112 is RealProducer™ and the content server 114 is RealServer™, although any other suitable format may be used instead. There is a stream converter 110 and a steam buffer 111 for each incoming channel feed at the input 101. The stream converters 110, the content encoder 112 and the DRM encoder 113 receive channel configuration information from the channel configuration database. The DRM encoder 113 also receives subscription information from the billing database 107.

The content server 114 supplies streamed channels to the Internet 102, from where they can be accessed by the mobile terminal 103 by applying a stream request to the content server 114 via the Internet 102.

Using the broadcast server 100, the user of the mobile terminal 103 is able to register and subscribe to services. When subscribed, the user of the mobile terminal 104 is able to select a channel from the content server 114 via the Internet 102, for instance using GPRS, which the content server 114 then streams to the mobile terminal 103. Reasonable quality video with mono audio can be obtained with a bit rate of 30 kbps. If the broadcast server 100 is arranged to receive broadcast television at the channel feeds 101, the user can thus be provided with broadcast television on their mobile terminal 103, and can change channel through a suitable provision on the user interface. This is achieved using GPRS as the bearer, and eliminates the need for the mobile terminal to be provided with broadcast television receiving hardware such as a DVB-T or DVB-H receiver. Similarly, very good quality stereo audio can be obtained with a bit rate of 30 kbps. 30 kbps has been found to be the maximum practical bandwidth with GPRS. 3G has been found to give practical bandwidths of 50-60 kbps. Multiple channels can be configured for each content source with different bitrates, one bit rate for GPRS, the other for 3G. This can also be made subscription tariff dependent.

This allows a user to receive broadcast radio services on the mobile terminal 103 through the broadcast server 100, without the need for the mobile terminal 103 to be provided with FM or other radio receiver hardware. These bit rates are selected so as to provide a compromise between reliability of service, bearing in mind the 128 kbps maximum bit rate of GPRS and the likelihood of imperfect channel conditions, and quality of content reproduction. Clearly, better coding provides a better quality of content for a given bitrate, although the coding technique selected should not place an unnecessarily decoding burden on the mobile terminal 103, since such is likely to increase the frequency of battery recharges.

The DRM encoder 113 adds digital rights management information to the content provided by the content encoder 112 such that only valid subscribers are able to properly decode the content streamed from the content server 114. In particular, the DRM encoder 113 adds a digital fingerprint to the content stream at approximately regular intervals. The digital fingerprint can be removed only by valid subscribers. Failure to remove the digital fingerprint results in correct decoding of the content streams being impossible. Thus, the inclusion of the digital fingerprint prevents users other than valid subscribers watching the broadcast television channels and listening to the broadcast radio channels. Furthermore, a different digital fingerprint can be applied to different content streams, so restrictions which apply to some channels may not apply to other channels.

Details of a software media player 120 included within and installed on the mobile terminal 103 are shown in FIG. 12. Referring to FIG. 12, the media player 120 includes a connection to the Internet, through a GPRS connection through a mobile telephone network (not shown) associated with the mobile network operator with which the user of the mobile terminal 103 has a subscription or other contract. The media player 120 includes also a communications interface 121, which feeds received streams to a DRM decoder 122. A custom codec 123 and a Real™ or MP4 codec 124 are both fed by the DRM decoder 122. Which of the Codecs 123 and 124 is used at a given time depends on the coding used at the broadcast server in respect of that channel. Both Real™ and MP4 codecs are able to process audio streams (for radio channels) as well as video streams (for television channels). Each of the codecs 123, 124 has an output connected to a display engine and user interface 125. A channel update module 126 is connected to the broadcast server 100 via the Internet 102, and obtains information about the available channels therefrom. This channel information is stored in a channel store 127. In response to a channel selection signal from the display engine and user interface 125, the channel store 127 provides channel specification information to the display engine and user interface 125. This channel specification information is passed from the display engine and user interface 125 to the communications interface 121, which uses the channel specification information to ensure that it receives the correct content stream at any given time.

A billing verification module 128 is connectable to the billing module 106 and the WAP registration module 104 of the broadcast server 100 through the Internet 102. These modules cooperate to register then subscribe the mobile terminal 103 to one or more services. The billing verification module uses the IMEI of the mobile terminal 103, which is provided from an IMEI store 129 forming part of the mobile terminal, to identify the mobile terminal. Once a subscription has been set up, an access code is sent from the billing module 106 to the billing verification module 128. This access code then is stored in a billing/DRM configuration store 130. The access code includes the digital fingerprint and identifies the location of the fingerprint within the content stream. The access code may relate to a single channel, or it may relate to a bundle of channels. The DRM decoder 122 is arranged to receive DRM information from the billing/DRM store 130. Using this information, the DRM decoder 122 is able to remove the digital fingerprint from the content stream, which allows the content stream to be able to be decoded correctly by the custom codec 123 or the Real/MP4 codec 124.

The communications interface 121 is arranged also to receive information from the billing/DRM configuration store 130. This allows the media player 120 to register with the broadcast server 100 and to subscribe therewith. The media player 120 includes a menu option for registering for television and/or radio services on selection of this menu item, the media player starts a WAP session and connects to the registration module 104 of the broadcast server. Subscription and billing also is performed via WAP. Once registration and any subscription and/or billing is complete, the WAP session is ended and the media player 120 returns to allow its other functions to be selected. Billing is performed on a per channel per unit of time basis, and on a subscription basis. A subscription has a duration or an end date, and can relate to a single channel or to a package of channels.

Referring to FIG. 13, a system 140 for providing a user with content comprises the broadcast server 100, the Internet 102 and the mobile terminal of FIGS. 12 and 13. The system also comprises a payment server 141, which is connected to the Internet 102. In this example, the payment server 141 is external to the broadcast server 100. The payment server 141 may be operated by a different entity to the entity operating the broadcast server 100. For instance, the payment server 141 may be operated by a mobile network operator. Also connected to the Internet 102 is a content server 142, which may be operated by the operator of the broadcast server 100 or by a different operator. The content server 142 and the payment server 141 may be operated by the same operator. The GPRS network which connects the mobile terminal 103 to the Internet 102 is shown at 143 in the Figure.

A detailed description of the use of digital fingerprints and obfuscation in the FIGS. 12 and 13 system will now be described. When streaming content, via GPRS or any other carrier, the data content blocks are transmitted over a different channel to the corresponding headers. Any suitable channels are used for this purpose.

The headers and the content blocks have the same content as those shown in and as described above with reference to FIG. 9, although the headers and content blocks are not sequential as shown. The headers each have a one-to-one relationship with content blocks, and are in the same sequence. No index headers or index entries are present. Since the transmission can be a continuous process, there are no physical start addresses associated with the content blocks, not are there first headers or content blocks.

Each of the content blocks 1204-1208 relates either to audio or video content. The video content blocks form a different stream to the audio content blocks. Each content block includes a presentation timestamp, so that a media player can relate audio content to the corresponding video content. The header of a content block 1204-1208 includes information which identifies which stream the content block relates to. In most cases, there will be only one audio stream and only one video stream, although this may vary.

In this example, the content blocks are produced by a RealProducer tool, so the headers 1201-1203 and the data in the content blocks 1204-1208 are compliant with the Real format. The content is decodable by a Real codec. Real is a trademark of RealNetworks, Inc. With Real, each content block 1204-1208 which relates to a video stream contains data relating to a whole video frame. Thus, each content block includes all the information relating to a frame, and relates to only one frame. A key frame is provided periodically, and each non-key frame between successive key frames detail differences between the previous frame and that frame. The interval between successive key frames is a settable parameter in RealProducer. The size of content blocks is variable. Where there is a lot of difference between two successive frames, the content block for the second frame includes a relatively large amount of data. Where there is less difference, the second frame typically contains less data. Where there is no difference between successive frames, the second content block may contain only a few bytes of data. Each header 1201-1203 includes information which identifies whether or not the corresponding content block 1204-1208 includes data of a key frame.

The offset to the start of content blocks is defined in a media header, which is sent first. Content block headers are constant length and define the variable length of the content block data. Content blocks are contiguous. Since the media player knows the offset to the first block from the main header and then the offset to the following blocks, the media player is able to determine the start of content blocks in the stream. The end of content is identified when the stream terminates or when an identifier for the index section is read as the start of the next content block header.

It is not possible for a machine or human operator to determine from examining the data of the content blocks 1204-1208 where the boundaries between the content blocks lie. However, each of the content headers 1201-1203 includes data which indicates the length in bytes of the corresponding content block 1204-1208. Thus, the start address of a content block 1204-1208 can be determined by adding the start address of the previous content block the length of the previous content block and one additional byte. Adding the length of the previous block to the start address of that block results in the address of the final byte of that block, thus the start address of the following content block is found by adding an additional byte to that address.

Thus, if any bits or bytes are added or taken away from any of the content blocks 1204-1208, the actual start addresses of all following content blocks will not match the addresses calculable from the headers 1201-1203. In this event, the data fed into a Real decoder will not be decoded properly, and the media player would probably stop working altogether and require closing and reopening before it could become operational.

The inventors exploit this to advantage. In particular, some content blocks 1204-1208 are each provided with one or more excess data items. The excess data item preferably is a digital fingerprint. In this example, the 2nd, Xth and Yth content blocks 1205, 1206, 1207 are provided with a digital fingerprint.

It clearly is important for a media player which is to playback the content to know where the excess data items are. Otherwise, data sent to a decoder in the media player may not be in the correct format, and thus will not be decoded properly and may crash the media player.

In some embodiments, excess data items are included at regular intervals (in a playback or presentation time sense) in the stream. For instance, excess data items can be included in the first content block having a timestamp immediately following an integer multiple of a predetermined excess data item interval, for instance 20 seconds. According to this technique, excess data items are included in the first content block having a presentation time after 20 seconds, in the first content block having a presentation time after 40 seconds, the first content block having a presentation time after 60 seconds and so on. Although the stream can be continuous, the presentation timestamps eventually cycle around to zero. However, it is a straightforward issue to determine whether a given timestamp is the first timestamp after an integer multiple of an excess data item interval.

The location of the excess data within the content block 1205-1207 also is important. In some embodiments, the excess data items are included at the same position in each of the content blocks 1205-1207 in which it present. For instance, the excess data may be included from byte 56 of those content blocks 1205-1207.

Bytes 57 onwards of the content block are retained, but after the digital fingerprint. If a content block includes 56 content blocks or fewer, then the excess data items are included at the end of that content block, after all of the content data. Thus, if a content block includes 20 bytes, then the excess data begins at the 21^{st} byte.

There are numerous ways in which a media player can be informed of the locations of excess data items in content data. The inventors have found that a particularly good solution is to utilise a pre-determined scheme to determine where to include excess data items before streaming the data, and to program the media player with details of that scheme.

For instance, there may be twenty different schemes that the media player is programmed to handle. Each scheme is identified by a different digital fingerprint scheme identifier. This may form part of the media code or may be identified to the media player in any other suitable way. A first scheme may involve digital fingerprints included at byte 56 in each of the first content blocks following integer multiples of 20 seconds, as described above. A second scheme may involve including a digital fingerprint at byte 32 of every content block immediately following integer multiples of 30 seconds. A third scheme may involve including a digital fingerprint at byte 32 of the content block six content blocks following integer multiples of 30 seconds. A fourth scheme may involve including a digital fingerprint at byte 32 of every content block immediately following integer multiples of 60 seconds and at byte 11 of every content block immediately following integer multiples of 30 seconds unless there is a digital fingerprint at byte 32 thereof, i.e. the location of the digital fingerprint alternates between byte 11 and byte 32 between successive occurrences of it. In another scheme, the content block in which the fingerprint is located is varied. For instance, the digital fingerprint may be located relative to a content block immediately following integer multiples of 40 seconds, at three content blocks following, seven content blocks following and two content blocks following in a repeated sequence. The more the location of the digital fingerprint is varied, the greater the protection that is afforded.

The length of the excess data items are not critical, although to avoid increasing the size of the resulting data by a significant degree the excess data preferably is not unduly long.

Since the excess data items are intended to be removed before decoding, the form (i.e. content) of the excess data items are not necessarily important. However, the inventors prefer that the excess data items are in the form of a digital fingerprint. Preferably, each occurrence of the digital fingerprint is the same, i.e. has the same data sequence. For instance, the digital fingerprint may be 5 bytes long. Even if a third party manages to determine the data constituting the digital fingerprint, data strings having the same data will be present at numerous locations in the content data, so this information alone would not be enough to allow the digital fingerprints to be removed.

As shown in FIG. 10A, an unmodified content block 1206 includes m bytes of data. In FIG. 10B, the content block 1206 is shown with a digital fingerprint 1301 added, and is labelled 1304. The digital fingerprint 1301 separates the m data bytes into two sections 1302, 1303. The first section 1302 includes data bytes 0 to n, and the second section 1303 includes data bytes n+1 to m. The length of the content block with the fingerprint is equal to m plus k bytes, where k is the size of the digital fingerprint. Using the example given above, n is 56 and k is 5.

To provide additional protection against unauthorised playback and/or copying, some or all of the content blocks are obfuscated before they are streamed. Where a content block includes an excess data item, such as a digital fingerprint 1301, then the excess data item is obfuscated along with the data forming the original content block. Simply, obfuscation comprises altering the data so that the resulting obfuscated data is different to the original data and cannot be decoded properly without first being deobfuscated. Obfuscation typically does not alter the amount of data, so the size of a content block is the same before and after obfuscation. Obfuscation is discussed above in relation to FIG. 3. The content block 1304 including the digital fingerprint 1301 is shown obfuscated at 1305 in FIG. 10C.

The obfuscated content block 1305 includes k plus m bytes, as with the digitally fingerprinted content block 1304.

If only one obfuscation scheme is used with all content, then the media player 58 knows what obfuscation is used without being informed of this.

If the obfuscation scheme is not the same for all content, then the media player 58 may need to be informed which obfuscation scheme is used with the content. In this case, an obfuscation identifier can be obtained from the broadcast server 100 in any suitable way. The obfuscation identifier 1306 identifies what obfuscation method was used by the DRM encoder 113 to obfuscate the data. This allows the media player it to perform the corresponding de-obfuscation method.

The content blocks 1203-1208 which include a digital fingerprint include more data than is indicated by their corresponding header 1201-1203

Following obfuscation of some or all of the content blocks 1205-1208, the resulting data is streamed to the mobile device 103.

When a user operates the media player on their mobile device 103 to receive a streamed television or radio channel, the mobile device communicates with the broadcast server 100 and arranges for an appropriate stream to be delivered to the mobile device. The headers and any obfuscation identifier are received separately. The media player then begins to read the headers and the content blocks relating to that content. The DRM decoding module 122 within the media player uses any obfuscation identifier to determine what obfuscation method is needed to de-obfuscate the content data 57. The DRM decoding module 122 also determines whether the media code needed to render the streamed content is present, having been obtained already during an authorisation process. The media code identifies the digital fingerprint 1301, and allows the media player 58 to determine in which content blocks 1205-1208 and where in those content blocks the digital fingerprint is present. This can occur in any suitable way. For instance, the media code may include a digital fingerprint location code, which identifies a predetermined scheme useable to remove the occurrences of the digital fingerprint.

The media player then is ready to render the streamed content. However, the media player is arranged to playback the content only if the digital fingerprint included in the streamed content blocks is the same as the digital fingerprint included in the media code. This provides a further check that the user is entitled to playback the content using the media player.

Without knowing where fingerprint is, it cannot be removed from the content by the media player. Also, the media player ensures that fingerprint present in the content is as expected before it will play the content.

In playing back the content, the DRM decoding module 122 de-obfuscates those content blocks which are obfuscated. For instance, in respect of the content block 1305 of FIG. 10C, the DRM validation module 44 performs the inverse of the obfuscation performed at the DRM processing module 21, thereby obtaining the fingerprinted content block 1304. In playing back the content, the DRM processing module 21 also removes fingerprints from the content blocks that include them. For instance, in respect of the content block 1304 of FIG. 10B, the DRM processing module 21 removes the digital fingerprint 1301, thereby obtaining the content block 1206 shown at FIG. 10A. The content blocks are fed to the codec 124 or the codec 123 of the media player only after de-obfuscation and after removal of the digital fingerprints. Failure to do either of these actions would result in incorrect data being fed to the codec, likely resulting in the crashing of the media player. At best, content would not be played back in a useable form.

If an other media player is used to attempt to playback the content, it will fail. In order to construct a media extractor which could extract useable content, the media extractor would need to know exactly what obfuscation method to use, and exactly where in the content blocks the excess data items are and what size they are. Thus, this technique provides substantial protection against unauthorised use of the content. Even with a relatively simple obfuscation method and relatively infrequent digital fingerprint inclusion, the protection afforded is relatively strong. Since the media player knows what de-obfuscation method is used and from what locations the digital fingerprint needs to be removed, it can playback the content correctly. However, the media player is not a media extractor, so cannot be used to extract the content in unprotected form for unauthorised use.

Another embodiment of the invention will now be described with reference to FIG. 13. This embodiment allows a user to build a library of content on a removable memory device, such as an MMC 150, and for the content to be protected by DRM. This embodiment is particularly suitable for use with content items which are video or audio files, although it has broader application.

When it is required to load one or more items of content onto the MMC 150 for the first time, a custom media player 151 is first loaded thereon. This can occur at a point-of-sale in a retail outlet, in a factory environment, on a user's PC or over-the-air. Whichever of these is used, blowing software firstly reads from the target MMC 150 the serial number of the MMC 150. This serial number typically is found at or near the beginning of a boot volume of the MMC 150, and typically is 8 bytes in length. The blowing software then generates a serial number for the media player 151. The blowing software then produces a media player 151 which includes an obfuscated version of the MMC serial number and an obfuscated version of the media player serial number. These serial numbers are obfuscated so that they cannot easily be identified from analysis of the data that comprises the media player 151. The media player 151 then is blown onto the MMC 150. Blowing in this sense comprises writing the data comprising the media player 151 into a data area of the MMC 150, typically at the beginning thereof. The media player 151 blown onto the MMC 150 is unique in the sense that it incorporates an MMC serial number and a media player serial number.

The blowing software at this time also prepares a sample content item 152 for blowing onto the MMC 150 along with the media player 151. The sample content item 152 includes a digital fingerprint located periodically throughout the data comprising the content item, in the manner described above in relation to the other embodiments. The content item may also be obfuscated as described above in relation to the other embodiments.

The blowing software generates an unlock code for the content item. The unlock code includes a copy of the digital fingerprint. If the location of the digital fingerprint may vary for different items of content, the unlock code also includes information allowing the media player 151 to determine the locations of the digital fingerprint. If the content data is obfuscated, the unlock code may also contain information allowing the media player 151 to determine how to de-obfuscate the content data.

Since this is the first content item being blown onto the MMC 150, the blowing software generates an encrypted unlock file 153. The unlock file 153 before encryption includes a header portion which includes the MMC serial number and the media player serial number. The unencrypted unlock file 153 also includes a line including a component identifying the sample content item 152 and the unlock code for the sample content item 152. The unlock file 153 is then encrypted. Any suitable form of encryption may be used. The inventors prefer that strong encryption is used. Their preferred form of encryption is triple Blowfish. Blowfish is a publicly available encryption algorithm. Applying the Blowfish algorithm to the unlock file 153 results in a Blowfish encrypted unlock file 153. Application of the Blowfish algorithm to the encrypted unlock file results in a double Blowfish encrypted unlock file. Application of the Blowfish algorithm to the double Blowfish encrypted unlock file results in a triple Blowfish encrypted unlock file, which in this embodiment is used as the encrypted unlock file 153. The encrypted unlock file 153 is blown onto the MMC 150.

The media player 151, the DRM protected sample content item 152 and the encrypted unlock file 153 can be blown onto the MMC 150 at the same time, or they may be blown separately. The result is that the MMC 150 has stored in the data portion thereof the media player 151, the DRM protected sample content item 152, and the encrypted unlock file 153. The sample content item 152 is then able to be consumed by a user.

To consume the sample content item 152, the user places the MMC 150 into a mobile device, if not already installed in a mobile device, and opens the media player application 151. The media player 151 on being opened determines whether the MMC serial number which is included in the media player 151 is the same as the MMC serial number which is stored in the boot section of the MMC 150. If it is the same, then the media player 151 operation is not impeded. If the serial numbers do not match, the media player 151 provides an error message and closes down. This ensures that the content (items of content and media player 151) on the MMC 150 cannot be copied to another MMC and played back from that other MMC.

The media player 151 shows the sample content item 152 in a content menu in a selectable manner. On selecting the sample content item 152, the media player 151 decrypts the encrypted unlock file 153. The media player 151 then detects the MMC serial number and media player serial number in the header of the unlock file 153. If these serial numbers match the actual MMC serial number and the media player 151 serial number respectively, operation of the media player 151 is not impeded. If either of the serial numbers do not match, the media player 151 provides an error message and closes down. This ensures that the media player 151 uses an unlock file 153 which was created specifically for that MMC and media player 151 combination, and thus provides additional protection against unauthorised copying.

The media player 151 after confirming that the MMC 150, the media player 151 and the unlock file 153 correspond to one another identifies the line forming part of that file which relates to the sample content item 152. This can occur in any suitable way. Most simply, the media player 151 identifies the relevant line in the unlock file 153 by searching for the line which contains the same title as the sample content item 152. If two different content items cannot have the same title, this always allows the media player 151 to determine the relevant line of the unlock file 153 without trial and error. If two lines of the unlock file 153 include the same title as the selected content item, the media player 151 performs some appropriate operation to determine which is the relevant line. Once the media player 151 has determined the relevant line of the unlock file 153, the media player 151 uses the unlock code forming part of that line to playback the sample content item 152. This involves determining that the digital fingerprint is the same as that present in the sample content item 152, and removing the digital fingerprint in the same manner as that described above in relation to the other embodiments. The media player 151 also performs any necessary de-obfuscation.

Thus, only the correct media player 151, including the MMC serial number, and relating specifically to the unlock file 153 which includes the means needed to playback the content item can playback the content item. Playback of the content item by another media player 151, even a media player 151 of the same type but created in respect of different content and/or a different MMC, is prevented. Thus, unauthorised copying of the content item is not worthwhile since no other media player 151 can playback the content item.

The user is able to add items of content to the content library stored on the MMC 150. Content can be added to the library only by the media player 151. Other content can be stored on the MMC 150, and accessed by other applications, but content can only be added to the library by the media player 151. This ensures that all content in the library can be protected by DRM and can be played back only by the media player 151. Addition of other content items occurs as follows.

A list of items of content available for purchase are stored on a remote server. The media player 151 can access the server, and the media player 151 and the server can authenticate one another. Following authentication, the media player 151 is able to provide a list of items of content available to purchase to a user through the interface provided on the display of the mobile device by the media player 151. The mechanism for allowing a user to select items of content for download is not important to this invention. Once an item of content has been approved for delivery to the MMC 150, the remote server protects the content item by providing it with a digital fingerprint and optionally also obfuscating it, as described above. The remoter sever also at this time generates an unlock code for the item of content, the unlock code including the means needed by the media player 151 to playback the item of content. The unlock code does not include the serial number of the media player 151. The remote server then communicates the unlock code and the title of the item of content to the media player 151. Delivery of the item of content 154 can be carried out as a background task. The item of content 154 may be delivered from a different remote server.

On receiving the unlock code from the remote server, the media player 151 updates the encrypted unlock file 153 to include a new line. This involves decrypting the unlock file 153, if it is not already in decrypted form in the media player 151, and adding a new line including the title of the new content item and the unlock code for that content item. The media player 151 then re-encrypts the unlock file 153 and overwrites the unlock file 153 stored on the MMC 150. At this stage, the encrypted unlock file 153 includes a line including the title and the unlock code for the new item of content. Once the item of content 154 has been downloaded, this is stored in the MMC 150 and thus forms part of the library of DRM protected content stored on the MMC 150.

The new content item can be played back in the same way as described above in relation to the sample content item 152.

Thus, the library of DRM protected content on the MMC 150 has a new content item 154 included in it. Furthermore, this item of content 154 is able to be played back from the MMC 150, and not from any other MMC (as identified by the MMC serial number), and can be played back only by the particular media player 151 using the particular unlock file 153. This is achieved without the addition of a further unlock file 153. Instead, the existing unlock file 153 is supplemented with a new line relating to the new content item 154 and which allows the media player 151 to playback that content item 154.

Since the size of the unlock file, and thus the encrypted unlock file 153, increases as further items of content 155 are added to the library of protected content stored on the MMC 150, it can be advantageous for the media player 151 to ensure that a suitable amount of the data part of the MMC 150 is reserved for the encrypted unlock file 153. This can avoid the need to rearrange data stored on the MMC 150 as content is added to the library, and can allow the encrypted unlock file 153 to remain at a location close to the start of the data portion of the MMC 150.

An advantage of this embodiment of the invention is the provision of a library of content which is protected and can be played back only from a specific MMC 150 by a media player 151 stored on that MMC 150. Thus, the content items 152, 154, 155 are not limited to playback on any particular mobile device. Instead, the MMC 150 can be moved to a different mobile device and access to all of the contents of the library will be available on that new mobile device through the media player 151. This allows a user to remain able to playback purchased content even when they upgrade or otherwise change their mobile device but without allowing playback of unauthorised copies of the content. The library of content also can be transferred between users, although only one version of it will ever be usable.

References in the above to serial numbers will be understood to refer to a unique or quasi-unique identifier. The serial number may comprise any suitable bit sequence, and may be a number only at binary level. The serial number may not be absolutely unique, since most of the advantages can be achieved if a particular serial number is used in a relatively small proportion of the number of MMCs or media players, as the case may be, in circulation. A serial number may be of any suitable length.

1. A media player operable to decode content data, the media player being arranged to use excess data location information to identify the location of an excess data item within each of plural content blocks forming part of the content data, to remove the excess data from the locations so determined, and to decode the content data following removal of the excess data.

2. A media player according to claim 1, in which the excess data location information is obtained over a channel separate from a source of the content data.

3. A media player according to claim 1, in which each occurrence of the excess data is a digital fingerprint.

4. A media player according to claim 3, in which the media player is arranged to determine whether data forming part of an authorisation or unlock code includes data corresponding to the digital fingerprint, and to decode the content data only in response to a positive determination.

5. A media player according to claim 4, in which each of the digital fingerprints each comprise a data sequence which is the same for each occurrence of the digital fingerprint.

6. A media player according claim 1, in which the media player is arranged to determine whether data forming part of an authorisation or unlock code includes data corresponding to a serial number of the media player, and to decode the content data only in response to a positive determination.

7. A media player according to any of claim 4, in which the media player is operable to derive the excess data location information from the authorisation or unlock code.

8. A media player according to claim 1, in which the media player is operable to use pre-programmed information to identify content blocks in which the excess data is located, and to use the excess data location information to determine the location of the excess data within those content blocks.

9. A media player according to claim 1, wherein the media player is stored on a portable memory device along with one or more items of content, each item of content being provided with excess data, and an unlock file.

10. A media player according to claim 9, wherein the unlock file includes a portable memory device serial number, and wherein the media player is arranged to validate a serial number of the portable memory device with the portable memory device serial number included in the unlock file before allowing playback of an item of content.

11. A media player according to claim 9, wherein the unlock file includes a media player serial number, and wherein the media player is arranged to validate a serial number of the media player with the media player serial number included in the unlock file before allowing playback of an item of content.

12. A media player according to any of claim 9, wherein the unlock file includes a respective unlock code for each item of content.

13. A media player according to claim 12, wherein the media player is arranged to supplement the unlock file with an unlock code for a new item of content and to overwrite the unlock file stored on the portable memory device.

14. Apparatus comprising means for producing a media player operable to decode content data, the media player being arranged to use excess data location information to identify the location of an excess data item within each of plural content blocks forming part of the content data, to remove the excess data from the locations so determined, and to decode the content data following removal of the excess data.

15. Apparatus as claimed in claim 14, wherein the apparatus is arranged to include a serial number with the media player.
